(19) United States
(12) Patent Application Publication
(10) Pub. No.: US 2019/0005725 A1
(43) Pub. Date: Jan. 3, 2019

(54) VIRTUAL OBJECT DISPLAY SYSTEM

(71) Applicant: FANUC CORPORATION, Yamanashi (JP)

(72) Inventor: Nobuhito OONISHI, Yamanashi (JP)

(21) Appl. No.: 16/003,553

(22) Filed: Jun. 8, 2018

(30) Foreign Application Priority Data
Jun. 29, 2017 (JP) 2017-127692

(51) Int. Cl. G06T 19/00; G06T 11/20; G05B 19/402

(52) U.S. Cl. CPC G06T 19/006; G06T 11/206; G05B 2219/31261; G05B 2219/39449; G05B 19/402

(57) ABSTRACT

A virtual object display system that generates, as the machine configuration of a control target, a graph including nodes, selects a node on which a virtual object is to be displayed, notifies the node on which the virtual object is to be displayed to a machine configuration management device, calculates transformation information which includes a coordinate value of a control axis node on a path in the graph from a marker node to the node of a display target and which is used for calculating the position and/or the posture of the node of the display target in a coordinate system of the marker node based on the graph, notifies the transformation information to an augmented information controller and transforms the coordinate value of a control axis into the position and/or the posture of the node of the display target in the coordinate system of the marker node.

This application is based on and claims the benefit of priority from Japanese Patent Application No. 2017-127692, filed on 29 Jun. 2017, the content of which is incorporated herein by reference.

### BACKGROUND OF THE INVENTION

### Field of the Invention

The present invention relates to a virtual object display system for performing a simulation using the technology of AR (Augmented Reality) and MR (Mixed reality).

### Related Art

Conventionally, in the field of machine tools controlled by numerical controllers, workpieces and fixtures are designed by CAD (computer-aided design) or the like. The designed fixture is used, and thus a machining program for machining the workpiece is produced. Then, the machine tool is controlled by the numerical controller based on the machining program, and thus the machining of the workpiece is realized.

Here, before the fixture and the workpiece designed and the machining program are actually placed in a manufacturing line, in order to check if they are appropriate, a machining simulation is generally performed.

When this machining simulation is performed by an operation check with an actual machine, the machining simulation naturally cannot be performed until an actual fixture is completed. Hence, disadvantageously, the process is stopped until the fixture is completed.

When at the time of the operation check after the completion of the fixture, a problem such as interference is found, and thus it is necessary to change the design of the fixture, the process is further extended. A cost for changing the design of the fixture is also needed. If the design of the fixture is not changed, the machining program needs to be changed, and in this case, a cycle time necessary for the machining may be extended beyond the original cycle time.

With consideration given to these problems, there is a technology in which the operation check is not performed with the actual machine but the machining simulation is virtually performed by computation processing with a personal computer or the like. For example, in a technology disclosed in Patent Document 1, all structures in machine tools are transformed into virtual objects, and thus a machining simulation is performed.

However, in the technology disclosed in Patent Document 1, it is necessary to produce not only virtual objects for a workpiece and a fixture but also virtual objects for the entire machine of a plurality of types of individual machine tools. Moreover, in order to reproduce the operation of the actual machine tools, it is necessary to install operation processing into the virtual objects of movable parts of the machine tools. In other words, disadvantageously, it is not easy to produce the virtual objects.

Furthermore, even when the virtual objects described above are produced, if the reproducibility of the virtual objects is low, a difference from the reality is disadvantageously produced.

A technology with consideration given to the problems on virtual objects as described above is disclosed in Patent Document 2. In the technology disclosed in Patent Document 2, the interior of a machine tool is acquired with camera images, and a tool holding portion or a workpiece holding portion which is previously registered is extracted as a feature point. Then, the virtual object of the tool or the workpiece previously registered is overlaid and displayed, based on the position of feature point, on the image of the machine tool actually shot. In this way, it is not necessary to produce the virtual object of the machine tool.

However, disadvantageously, in the technology disclosed in Patent Document 2, it is necessary to fix the direction of shooting with a camera to a preset direction, and thus it is impossible to change a viewpoint for checking how a machining simulation is performed.

On the other hand, in the field of image processing technologies in recent years, an augmented reality technology such as for overlaying virtual objects on objects actually present in a real space and displaying them has been generally utilized. In the following description, information displayed by the augmented reality technology as described above is referred to as “augmented information”.

The augmented reality technology as described above is utilized, and thus it is possible to extract a specific feature point (for example, a marker) of an image shot with a camera and perform overlay display on the augmented information such as virtual objects. Moreover, it is possible to arbitrarily change the direction of shooting with the camera. Hence, the augmented reality technology as described above can be appropriately utilized, and thus it is possible to remove the problem in the technology disclosed in Patent Document 2 described above.

A basic technology for the augmented reality technology such as AR and MR as described above is disclosed in Non-Patent Document 1. In the technology disclosed in Non-Patent Document 1, a see-through type HMD (Head Mounted Display) is used as a display device, and the three-dimensional position of a marker serving as the reference coordinates of a virtual object display is detected from image information obtained by a small-sized camera attached to the HMD. Then, by the provision of virtual object images in which parallax is given to both eyes of a user, it is possible to display, as a three-dimensional object, a virtual object in a three-dimensional space of the real world seen through a HMD screen.

Specifically, in the technology disclosed in Non-Patent Document 1, as shown in FIG. 27, a plurality of coordinate systems are dealt with. In this point, a virtual object is represented on a marker coordinate system which is a coordinate system with a feature point set to a zero point. Then, processing for determining a coordinate transformation matrix from the marker coordinate system into a camera coordinate system is performed.

Then, the coordinate transformation matrix obtained in this processing is used, and thus it is possible to drawn the virtual object in appropriate positions of left and right screens in the HMD.

The augmented reality technology disclosed in Non-Patent Document 1 and the like as described above is utilized, and thus the virtual object is displayed within an actual machine tool, and the machining simulation can be performed.

For example, when as shown in FIG. 28, the feature point is set to a previously registered marker, as the marker is moved, a virtual object is moved. In other words, the virtual object follows the marker.

By utilization of this, the marker is arranged on a movable portion of an actual machine tool, and thus the virtual object can be moved according to the actual movement of a table. For example, as shown as (29A) on the left of FIG. 29, a marker is arranged on a movable table which is a movable portion of an actual machine tool. Then, as shown as (29B) in the center of FIG. 29, a virtual object is displayed with the marker set to the zero point. Furthermore, as shown as (29C) on the right of FIG. 29, as the movable table is moved along, for example, an X axis, the virtual object follows the marker.

In this way, it is possible to perform the machining simulation without the entire machine tool set to virtual objects and without the movable portion of the machine tool being reproduced.

Patent Document 1: Japanese Patent No. 4083554

Patent Document 2: Japanese Patent No. 5384178

Patent Document 3: Japanese Unexamined Patent. Application, Publication No. 2012-58968

Patent Document 4: Japanese Patent No. 5872923

Non-Patent Document 1

“Augmented reality system based on marker tracking and its calibration”, “online”, “searched on Nov. 27, 2016”, Internet <URL:

http://intron.kz.tsukuba.ac.jp/tvrsj/4.4/kato/p-99_VRSJ4_4.pdf>

### SUMMARY OF THE INVENTION

However, when as shown in FIG. 29, the marker is arranged on the movable portion of the actual machine tool, there are a plurality of problems as shown in FIG. 30.

For example, there is a problem in which as shown as (30A) on the left of FIG. 30, it is likely that it is impossible to distinguish the marker. This is because although in order to draw augmented information, it is necessary to capture the marker with a camera, it is likely that it is impossible to distinguish the marker as a result of the movement or rotation of the movable portion on which the marker is installed. In this point, a technology disclosed in Patent Document 4 is utilized, and thus it is possible to continue the display of the augmented information even after the marker cannot be distinguished. However, in the technology disclosed in Patent Document 4, since it is thereafter impossible to detect the movement of the marker arranged on the movable portion, the augmented information displayed is not moved after the marker cannot be distinguished. Hence, even if the technology disclosed in Patent Document 4 is utilized, when the marker cannot be distinguished, it is impossible to perform appropriate machining simulation.

There is also a problem in which as shown as (30B) in the center of FIG. 30, it is likely that the moving speed of the movable portion is high, and thus recognition processing for the marker cannot catch up therewith.

There is also a problem in which as shown as (30C) on the right of FIG. 30, it is likely that the marker cannot be arranged on the movable portion in the first place. The case where the marker cannot be arranged on the movable portion refers to, for example, a case where the movable portion itself is realized by a virtual object.

In addition, it can also be considered that a plurality of virtual objects are displayed on one marker. For example, it can be considered that as shown as (31A) on the left of FIG. 31, a workpiece and a fixture and a tool are displayed as virtual objects. It can also be considered that as shown as (31B) on the right of FIG. 31, a workpiece and a fixture and a table are displayed as virtual objects. There is also a problem in which in such cases, the marker is arranged on the movable portion such that virtual objects which do not need to be moved are moved together.

With consideration given to these problems, when the machining simulation is performed on the machine tool, it is preferable to be able to fixedly install the marker in a predetermined position without the marker itself being moved.

However, when the marker is fixedly installed, a virtual object which is displayed with the marker set to the zero point is not moved. In this configuration, it is impossible to perform the machining simulation.

Hence, when the marker is fixedly installed, it is necessary to move/rotate the virtual object on the marker coordinate system according to the movement of the movable portion in the machine tool.

By contrast, the movable portion in the actual machine tool is moved/rotated by the operation of a control axis controlled by a numerical controller. The coordinate system of the control axis (hereinafter also referred to as the “control axis coordinate system”) is managed by the numerical controller so as to be specific to each machine tool.

In other words, the marker coordinate system and the control axis coordinate system are different from each other, and thus it is impossible to properly perform the machining simulation only by the amount of movement of the control axis.

As a technology for solving this problem, for example, a first method can be considered in which position information on the marker coordinate system is changed according to position information on the control axis coordinate system. However, in this method, it is necessary to set relationship information for transforming the amount of movement in the control axis coordinate system into the amount of movement in the marker coordinate system.

As a technology for making it unnecessary to set the relationship information, for example, a second method can be considered in which a plurality of pieces of image sensing data obtained by sensing the images of positions of a marker fixed in a position seen from a camera, a tool moved as the control axis is moved and the like are acquired, and in which the relationship information for transforming the amount of movement in the control axis coordinate system into the amount of movement in the marker coordinate system is estimated from the positon of the tool in the marker coordinate system calculated from the acquired image sensing data and coordinate values in the control axis coordinate system.

However, in the second method, a transformation formula needs to be previously registered so as to include an unspecified number for each of the configurations of machines, and thus only previously prepared machine configurations can be used. In addition to the recognition of the marker, an image recognition technology for recognizing the positions of a tool and the like is required.

Furthermore, both in the first and second methods, a transformation formula is needed for each virtual object, and since this transformation formula is originally used for the amount of movement, a means for recognizing the initial position is needed. In order to recognize the initial position, it is necessary to place an initial position detection marker on a target on which the virtual object is arranged or to perform image recognition on the target, with the result that when the number of virtual objects is increased, the recognition means for the individual virtual objects are needed.

Hence, an object of the present invention is to provide a virtual object display system which can display a virtual object with a simple method.

(1) A virtual object display system (for example, a virtual object display system 10 which will be described later) according to the present invention which includes a machine configuration management device (for example, a machine configuration management device 100 which will be described later) and an augmented information controller (for example, a augmented information controller 200 which will be described later), in which the machine configuration management device includes a graph generation portion (for example, a graph generation portion 111 which will be described later), a control point coordinate system insertion portion (for example, a control point coordinate system insertion portion 113 which will be described later), a node information notification portion (for example, a node information notification portion 114 which will be described later), a transformation information calculation portion (for example, a transformation information calculation portion 115 which will be described later) and a transformation information notification portion (for example, a transformation information notification portion 116 which will be described later) and in which the augmented information controller includes a node selection portion (for example, a node selection portion 211 which will be described later), a selection node notification portion (for example, a selection node notification portion 212 which will be described later) and a coordinate information transformation portion (for example, a coordinate information transformation portion 213 which will be described later), where the graph generation portion generates, as a machine configuration of a control target, a graph in which constituent elements including markers are nodes, the control point coordinate system insertion portion inserts a control point and a coordinate system into the graph, the node information notification portion notifies information of a node which can be displayed to the augmented information controller, the node selection portion selects a node on which a virtual object is desired to be displayed, the selection node notification portion notifies the node on which the virtual object is desired to be displayed to the machine configuration management device, the transformation information calculation portion calculates transformation information which includes, as a variable, a coordinate value of a control axis node on a path in the graph from a marker node to a node of a display target and which is used for calculating a position and/or a posture of the node of the display target in a coordinate system of the marker node based on the graph, the transformation information notification portion notifies the transformation information to the augmented information controller and the coordinate information transformation portion uses the transformation information so as to transform the coordinate value of a control axis which is notified into the position and/or the posture of the node of the display target in the coordinate system of the marker node.

(2) Preferably, the virtual object display system (for example, a virtual object display system 10 which will be described later) according to (1) further includes a display device (for example, a head mounted display 300 which will be described later), where the augmented information controller (for example, an augmented information controller 200 which will be described later) further includes: an augmented information display data calculation portion (for example, an augmented information display data calculation portion 214 which will be described later) which calculates, based on the position and/or the posture of the node of the display target in the coordinate system of the marker node, augmented information da splay data for calculating, with the display device, the virtual object as augmented information; and an augmented information display data notification portion (for example, an augmented information display data notification portion 215 which will be described later) which notifies the augmented information display data to the display device.

(3) Preferably, in the virtual object display system (for example, a virtual object display system 10 which will be described later) according to (1) or (2), the coordinate information transformation portion (for example, a coordinate information transformation portion 213 which will be described later) transforms, as the coordinate value of the control axis, a coordinate value received from a numerical controller (for example, a numerical controller 150 which will be described later) into the position and/or the posture of the node of the display target in the coordinate system of the marker node.

(4) Preferably, in the virtual object display system (for example, a virtual object display system 10 which will be described later) according to any one of (1) to (3), the graph generation portion (for example, a graph generation portion 111 which will be described later) adds a plurality of the marker nodes to the graph, the transformation information calculation portion (for example, an transformation information calculation portion 115 which will be described later) calculates the transformation information for calculating the position and/or the posture of the node from the coordinate system of the marker nodes and the transformation information notification portion (for example, an transformation information notification portion 116 which will be described later) notifies the transformation information to the augmented information controller.

(5) Preferably, in the virtual object display system (for example, a virtual object display system 10 which will be described later) according to any one of (1) to (3), the graph generation portion (for example, a graph generation portion 111 which will be described later) adds a base marker node, and the transformation information calculation portion (for example, an transformation information calculation portion 115 which will be described later) notifies the augmented information controller of the transformation information with reference to the coordinate system of the base marker node and the transformation information between the coordinate system of the base marker node and the coordinate system of the marker node.

(6) Preferably, in the virtual object display system (for example, a virtual object display system 10 which will be described later) according to any one of (1) to (5), the augmented information controller (for example, an augmented information controller 200 which will be described later) further includes a storage portion (for example, a storage portion 220 which will be described later) having data of the graph.

(7) Preferably, the virtual object display system (for example, a virtual object display system 10 which will be described later) according to any one of (1) to (6), further includes a server which stores data of the graph.

(8) Preferably, in the virtual object display system (for example, a virtual object display system 10 which will be described later) according to any one of (1) to (7), the machine configuration management device (for example, a machine configuration management device 100 which will be described later) is integrated with a numerical controller (for example, a numerical controller 150 which will be described later) of a machine tool (for example, a machine tool 400 which will be described later).

(9) Preferably, in the virtual object display system (for example, a virtual object display system 10 which will be described later) according to any one of (1) to (7), the machine configuration management device (for example, a machine configuration management device 100 which will be described later) is present on a cloud.

According to the present invention, it is possible to display a virtual object with a simple method.

### BRIEF DESCRIPTION OF THE DRAWINGS

FIG. 1 is a block diagram showing a basic configuration of an entire embodiment of the present invention;

FIG. 2 is a functional block diagram of a machine configuration management device 100 according to the embodiment of the present invention;

FIG. 3 is a functional block diagram of a numerical controller 150 according to the embodiment of the present invention;

FIG. 4 is a functional block diagram of an augmented information controller 200 according to the embodiment of the present invention;

FIG. 5 is an illustrative diagram of a method of generating a machine configuration tree is the embodiment of the present invention;

FIG. 6 is an illustrative diagram of the method of generating the machine configuration tree in the embodiment of the present invention;

FIG. 7 is an illustrative diagram of the method of generating the machine configuration tree in the embodiment of the present invention;

FIG. 8 is a flowchart showing the method of generating the machine configuration tree in the embodiment of the present invention;

FIG. 9A is an illustrative diagram of a parent-child relationship of the constituent elements of a machine in the embodiment of the present invention;

FIG. 9B is an illustrative diagram of the parent-child relationship of the constituent elements of a machine in the embodiment of the present invention;

FIG. 10A is an illustrative diagram of a method of inserting a unit into the machine configuration tree;

FIG. 10B is an illustrative diagram of the method of inserting the unit into the machine configuration tree;

FIG. 10C is an illustrative diagram of the method of inserting the unit into the machine configuration tree;

FIG. 11 is a diagram showing an example of a machine configuration according to the embodiment of the present invention;

FIG. 12A is a diagram showing an example of the machine which is a target for the generation of the machine configuration tree;

FIG. 12B is a diagram showing an example of a machine configuration tree corresponding to the machine which is the target for the generation of the machine configuration tree;

FIG. 13 is a diagram showing an example where a coordinate system and a control point are inserted into each node in the machine in the embodiment of the present invention;

FIG. 14 is a diagram showing an example of the machine configuration tree into which the coordinate systems and the control points are inserted in the embodiment of the present invention;

FIG. 15A is a diagram showing an example of the machine in which an offset and a posture matrix are inserted into each node in the embodiment of the present invention;

FIG. 15B is a diagram showing an example where the offset and the posture matrix are inserted into each node in the machine in the embodiment, of the present invention;

FIG. 16 is a diagram showing an operation flow of inserting the control point into the machine configuration tree in the embodiment of the present invention;

FIG. 17 is a diagram showing an example of the machine configuration tree into which the coordinate systems and the control points are inserted in the embodiment of the present invention;

FIG. 18 is a diagram showing an example of information used when transformation information is generated in the embodiment of the present invention;

FIG. 19 is a diagram showing an example of the information used when the transformation information is generated in the embodiment of the present invention;

FIG. 20 is a diagram showing an operation flow of a method of displaying a virtual object in the embodiment of the present invention;

FIG. 21A is a diagram showing an example of the embodiment of the present invention;

FIG. 21B is a diagram showing the example of the embodiment of the present invention;

FIG. 22 is a diagram showing a relationship between a marker coordinate system and a camera coordinate system and the transformation information;

FIG. 23A is a diagram showing the example of the embodiment of the present invention;

FIG. 23B is a diagram showing the example of the embodiment of the present invention;

FIG. 24A is a diagram showing the example of the embodiment of the present invention;

FIG. 24B is a diagram showing the example of the embodiment of the present invention;

FIG. 25A is a diagram showing the example of the embodiment of the present invention.;

FIG. 25B is a diagram showing the example of the embodiment of the present invention;

FIG. 26 is a diagram showing, when a plurality of marker coordinate systems are present, a relationship between the marker coordinate systems and the camera coordinate system and the transformation information;

FIG. 27 is a diagram showing the marker coordinate system;

FIG. 28 is a diagram showing the display of the virtual objects;

FIG. 29 is a diagram showing a case where the marker is installed on a movable portion;

FIG. 30 is a diagram showing problems when the marker is installed on the movable portion; and

FIG. 31 is a diagram showing a case where a plurality of virtual objects are associated with the marker.

### DETAILED DESCRIPTION OF PR INVENTION

### <1. Configuration of Virtual Object Display System>

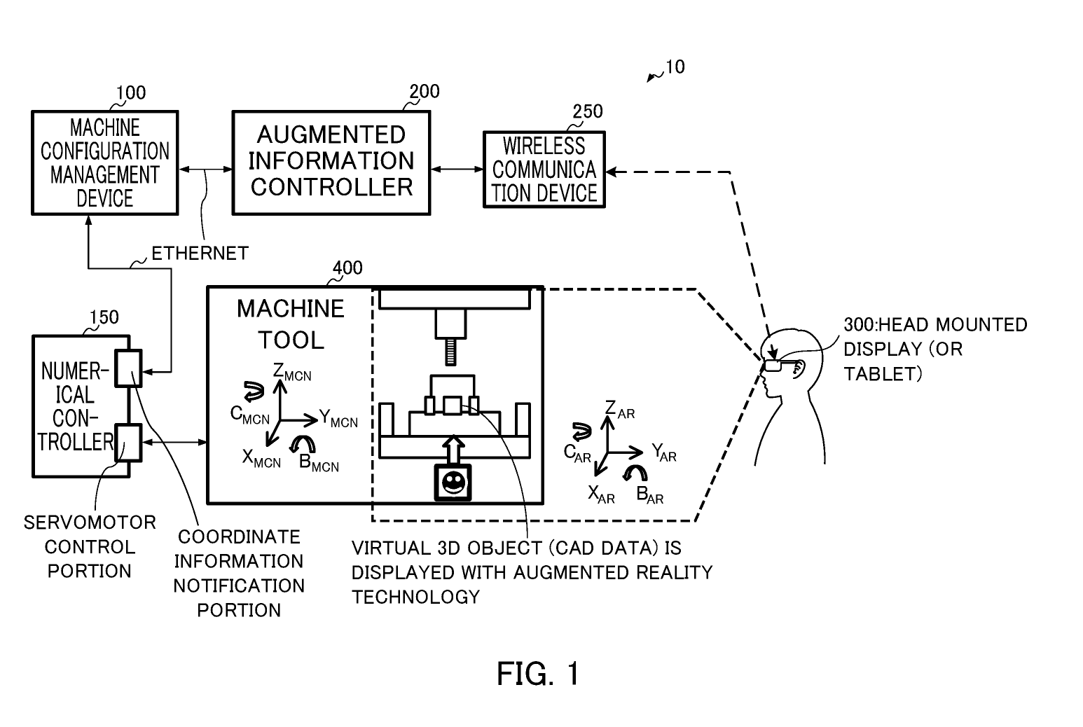

An embodiment of the present invention will then be described in detail with reference to drawings. The configuration of the entire present embodiment will first be described with reference to FIG. 1.

A virtual object display system 10 according to the present embodiment includes a machine configuration management device 100, a numerical controller 150, an augmented information controller 200, a wireless communication device 250, a head mounted display 300 and a machine tool 400.

The machine configuration management device 100 is a device specific to the present embodiment, produces a graph (hereinafter also referred to as the “machine configuration tree”) in which the constituent elements of the machine tool 400 are nodes and uses the graph to manage a machine configuration, and thus the augmented information controller 200 which will be described later can perform control by utilization of data of the machine configuration based on the machine configuration tree.

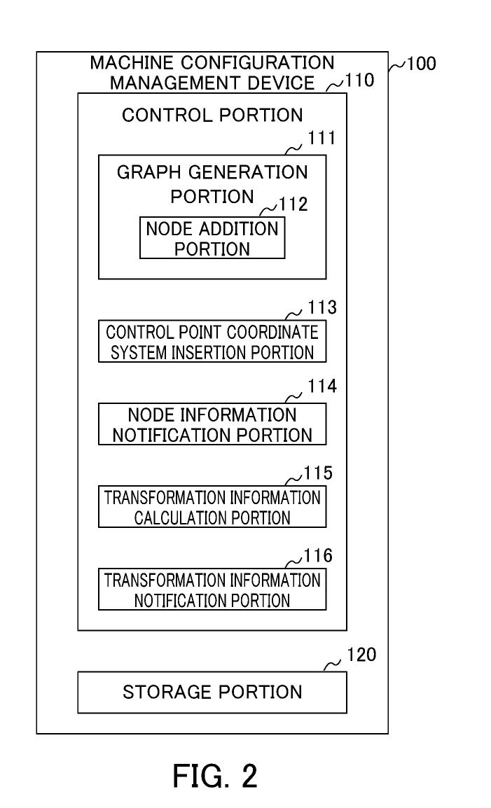

More specifically, the machine configuration management device 100 uses a method described in <5. Generation of machine configuration tree> which will be described later so as to generate the machine configuration tree representing the configuration of the machine tool 400, and furthermore, markers are added and registered as the nodes of the machine configuration tree or when a marker is adhered to the existing node, the node is recognized as a marker node. Since the machine configuration tree has mutual position relationship information of the individual nodes, the markers are included as the nodes on the machine configuration tree, and thus in the augmented information controller 200 which will be described later, for all the nodes on the machine configuration tree, the relationship of position/posture with the markers is found. The detailed configuration of the machine configuration management device 100 will be described later with reference to FIG. 2.

The numerical controller 150 is a device which has a function as a general numerical controller and a function of communicating with the machine configuration management device 100. The numerical controller 150 is connected to the machine tool 400 so as to be able to communicate therewith. The numerical controller 150 uses the amounts of movement of individual control axes output based on a machining program incorporated in the numerical controller 150 itself and thereby controls the machine tool 400 so as to machine a workpiece.

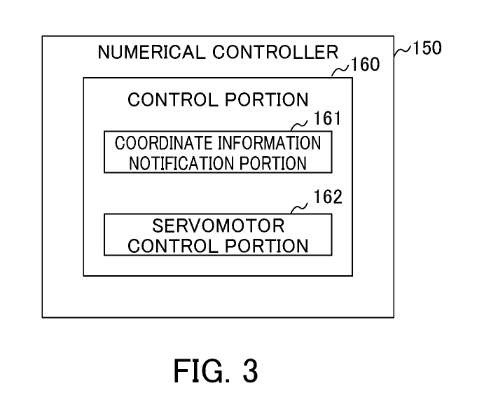

The numerical controller 150 outputs, to the augmented information controller 200, the amounts of movement of the individual control axes output based on the machining program. As described above, the numerical controller 150 outputs the amounts of movement both to the machine configuration management device 100 and the machine tool 400. In this point, the output of the amounts of movement from the numerical controller 150 to the machine configuration management device 100 may be performed in synchronization with or asynchronously with the output of the amounts of movement from the numerical controller 150 to the machine tool 400. The detailed configuration of the numerical controller 150 will be described later with reference to FIG. 3.

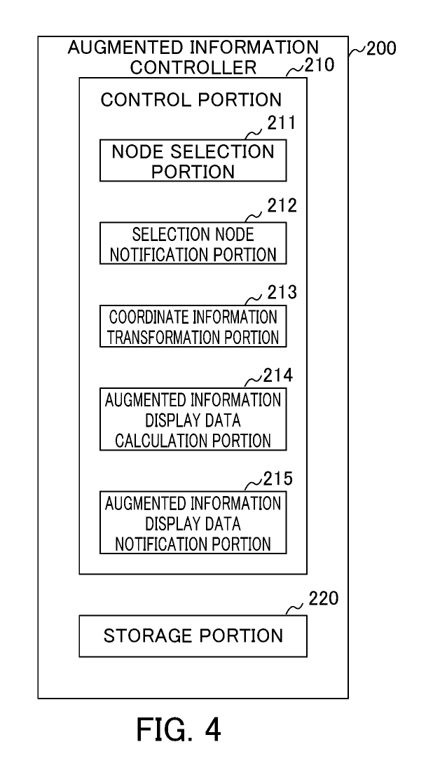

The augmented information controller 200 is a device specific to the present embodiment, uses an augmented reality technology so as to calculate the display position and the display angle of a virtual object and thereby performs control for appropriately displaying the virtual object. The detailed configuration of the augmented information controller 200 will be described later with reference to FIG. 4.

The wireless communication device 250 is connected to the augmented information controller 200 so as to be able to communicate therewith, and acquires a virtual object output by the augmented information controller 200 and the display position and the display angle thereof. The information output by the augmented information controller 200 corresponds to a camera coordinate system. The information output by the augmented information controller 200 is transmitted to the head mounted display 300 in conformity with wireless communication standards such as Wi-Fi.

The wireless communication device 250 receives, by wireless communication, from the head mounted display 300, information acquired by image sensing with a camera included in the head mounted display 300. Then, the wireless communication device 250 outputs the received information to the augmented information controller 200.

The head mounted display 300 is a general head mounted display (hereinafter referred to as the “HMD” as necessary), and acquires the virtual object output by the augmented information controller 200 and the display position and the display angle thereof through the wireless communication device 250. Then, based on the acquired information, the virtual object is displayed on a display included in the head mounted display 300 itself. The acquired information corresponds to the camera coordinate system as described above. The head mounted display 300 also outputs, through the wireless communication device 250, to the augmented information controller 200, the information acquired by image sensing with the camera included in the head mounted display 300 itself.

The machine tool 400 is a general machine tool, and moves/rotates the individual control axes according to the amounts of movement of the individual control axes output from the numerical controller 150.

In the present embodiment, in the configuration described above, a user references the virtual object displayed according to a marker coordinate system on the display of the head mounted display 300, and also references, over the display, the actual structure of the machine tool 400 which is moved according to the amounts of movement of the individual control axes. In this way, the user can observe how a machining simulation is performed.

The configuration shown in FIG. 1 is simply an example. For example, the head mounted display 300 may be realized by a tablet-type terminal instead of the HMD. Part or the whole of the functions of the machine configuration management device 100 may be incorporated in the numerical controller 150. Part or the whole of the functions of the augmented information controller 200 may be incorporated in the head mounted display 300 or the numerical controller 150. Although the augmented information controller 200 may be realized by a single device, the augmented information controller 200 may be realized by a combination of a plurality of devices. Although the augmented information controller 200 may be realized by a device installed in the vicinity of the numerical controller 150 or the machine tool 400, the augmented information controller 200 may be realized by a server device or the like installed far away from the numerical controller 150 or the machine tool 400 through a network. Furthermore, individual communication connections may be wired connection or wireless connection. For example, although in the figure, the example where the communication connections of the machine configuration management device 100, the numerical controller 150 and the augmented information controller 200 are performed by wired connection in conformity with Ethernet (registered trade mark) is shown, the connections may be wireless connection.

### <2. Configuration of Machine Configuration Management Device>

FIG. 2 is a functional block diagram of the machine configuration management device 100. The machine configuration management device 100 includes a control portion 110 and a storage portion 120, the control portion 110 includes a graph generation portion 111, a control point coordinate system insertion portion 113, a node information notification portion 114, a transformation information calculation portion 115 and a transformation information notification portion 116 and the graph generation portion 111 includes a node addition portion 112.

The control portion 110 is a processor which comprehensively controls the machine configuration management device 100. The control portion 110 reads, through a bus, a system program and an application program stored in a ROM (unillustrated), and realizes, according to the system program and the application program, the functions of the graph generation portion 111, the node addition portion 112, the control point coordinate system insertion portion 113, the node information notification portion 114, the transformation information calculation portion 115 and the transformation information notification portion 116 included in the control portion 110.

The graph generation portion 111 generates, in a graph form, the machine configuration of the machine tool 400 including markers. Furthermore, the node addition portion 112 included in the graph generation portion 111 adds nodes to the generated graph. The detailed operation thereof will be described in detail in “5. Generation of machine configuration tree” below.

The control point coordinate system insertion portion 113 inserts a control point and a coordinate system into the graph of the machine configuration. The detailed operation thereof will be described in detail in “6. Automatic insertion of control point and coordinate value” below.

The node information notification portion 114 notifies the augmented information controller 200 which will be described later of information of nodes which can be displayed.

As will be described later, the transformation information calculation portion 115 receives a notification of a node on which the virtual object is desired to be displayed from a selection node notification portion 212 of the augmented information controller 200, and thereafter calculates transformation information which includes, as a variable, a coordinate value of a control axis node on a path from a marker node to a node of a display target and which is used for calculating the position and/or the posture of the node of each display target in the coordinate system of the marker node based on the graph. The transformation information described above may have a matrix form, a vector form or a roll-pitch-yaw form. The detailed operation thereof will be described in detail in. “7. Calculation of transformation information” below.

The transformation information notification portion 116 notifies the transformation information calculated by the transformation information calculation portion 115 to a coordinate information transformation portion 213 of the augmented information controller 200.

The storage portion 120 stores information on the machine configuration tree generated by the graph generation portion 111.

The detailed operations of the graph generation portion 111, the node information notification portion 114, the transformation information calculation portion 115, the transformation information notification portion 116 and the storage portion 120 will be described in detail in “8. Method of displaying virtual object” below.

### <3. Configuration of Numerical Controller>

FIG. 3 is a functional block diagram of the numerical controller 150. The numerical controller 150 includes a control portion 160, and the control portion 160 includes a coordinate information notification portion 161 and a servomotor control portion 162.

The control portion 160 is a processor which comprehensively controls the numerical controller 150. The control portion 160 reads, through a bus, a system program and an application program stored in the ROM (unillustrated), and realizes, according to the system program and the application program, the functions of the coordinate information notification portion 161 and the servomotor control portion 162 included in the control portion 160.

The coordinate information notification portion 161 notifies coordinate information of the machine tool 400 being operated to the coordinate information transformation portion 213 of the augmented information controller 200. The servomotor control portion 162 receives a movement command amount of each axis from the control portion 160, and outputs the command of each axis to a servomotor (unillustrated).

Although the numerical controller 150 includes other constituent elements included in a normal numerical controller in order to perform numerical control on the machine tool 400, the description thereof will be omitted.

### <4. Configuration of Augmented Information Controller>

FIG. 4 is a functional block diagram of the augmented information controller 200. The augmented information controller 200 includes a control portion 210 and a storage portion 220, and the control portion 210 includes a node selection portion 211, the selection node notification portion 212, the coordinate information transformation portion 213, an augmented information display data calculation portion 214 and an augmented information display data notification portion 215.

The control portion 210 is a processor which comprehensively controls the augmented information controller 200. The control portion 210 reads, through a bus, a system program and an application program stored in the ROM (unillustrated), and realizes, according to the system program and the application program, the functions of the node selection portion 211, the selection node notification portion 212, the coordinate information transformation portion 213, the augmented information display data calculation portion 214 and the augmented information display data notification portion 215 included in the control portion 210.

The node selection portion 211 selects a node on which the virtual object is desired to be displayed.

The selection node notification portion 212 notifies the node selected by the node selection portion 211 to the transformation information calculation portion 115 of the machine configuration management device 100.

The coordinate information transformation portion 213 calculates the position and/or the posture of the virtual object in the marker coordinate system from the coordinate value of each control axis periodically received from the numerical controller 150 based on the transformation information received from the machine configuration management device 100.

The augmented information display data calculation portion 214 calculates, based on the technology of AR, MR or the like, augmented information display data for displaying the augmented information of the virtual object and the like. More specifically, the augmented information display data calculation portion 214 first uses information from the head mounted display 300 so as to transform the position and/or the posture of the virtual object in the marker coordinate system into the position and/or the posture in the camera coordinate system. Furthermore, the augmented information display data calculation portion 214 transforms the position and/or the posture into the position and/or the posture in a screen coordinate system.

The augmented information display data notification portion 215 transmits the augmented information display data calculated by the augmented information display data calculation portion 214 to the head mounted display 300 through the wireless communication device 250. The augmented information display data includes the shape and the like of the virtual object and the display position, the display angle and the like of the virtual object transformed into coordinate values in the screen coordinate system.

The storage portion 220 stores information on the graph generated by the graph generation portion 111 of the machine configuration management device 100.

The detailed operations of the node selection portion 211, the selection node notification portion 212, the coordinate information transformation portion 213, the augmented information display data calculation portion 214, the augmented information display data notification portion 215 and the storage portion 220 will be described in detail in “8. Method of displaying virtual object” below.

### <5. Generation of Machine Configuration Tree>

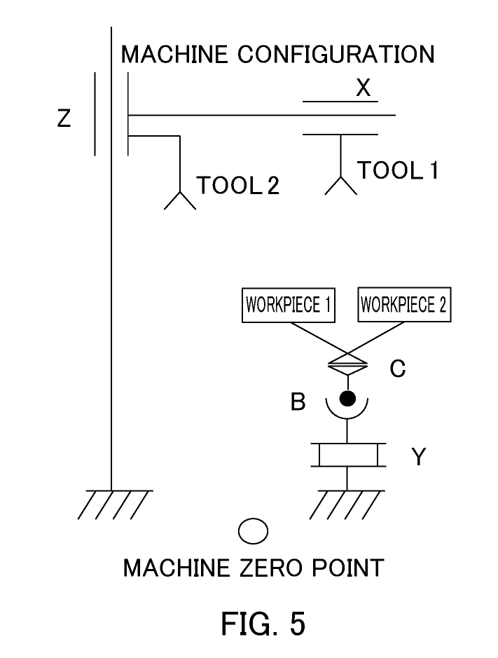

The machine configuration management device 100 according to the embodiment of the present invention first generates the graph showing the machine configuration. A method of generating a machine configuration tree as an example of the graph will be described in detail with reference to FIGS. 5 to 11.

As the example, the method of generating the machine configuration tree representing the configuration of a machine shown in FIG. 5 will be described. In the machine of FIG. 5, it is assumed that an X axis is set perpendicular to a Z axis, that a tool 1 is installed in the X axis and that a tool 2 is installed in the Z axis. On the other hand, it is assumed that a B axis is set on a Y axis, that a C axis is set on the B axis and that a workpiece 1 and a workpiece 2 are installed in the C axis. The method of representing the machine configuration as the machine configuration tree will be described below.

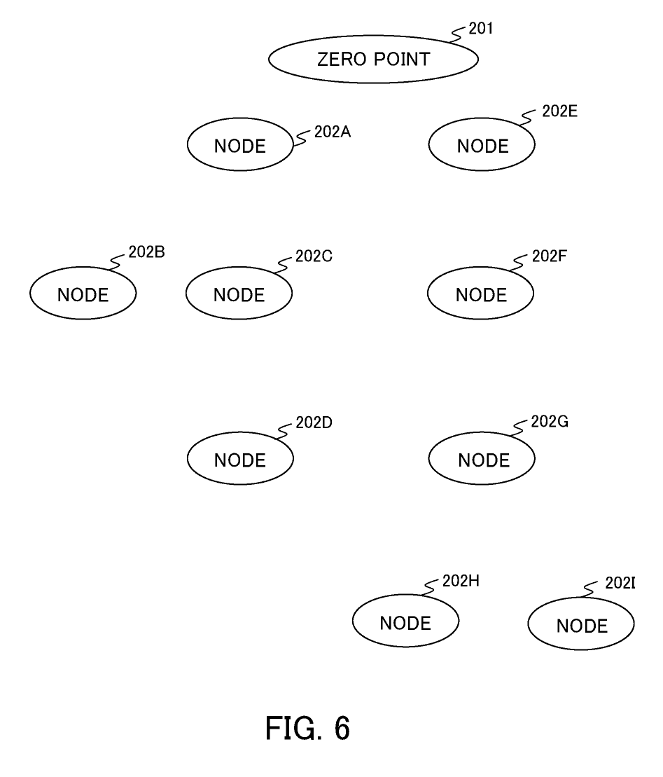

First, as shown in FIG. 6, only a zero point 201 and nodes 202A to 202I are arranged. In this stage, there is no connection between the zero point 201 and the nodes 202 and between the nodes 202, and the names of the zero point and the nodes are not set.

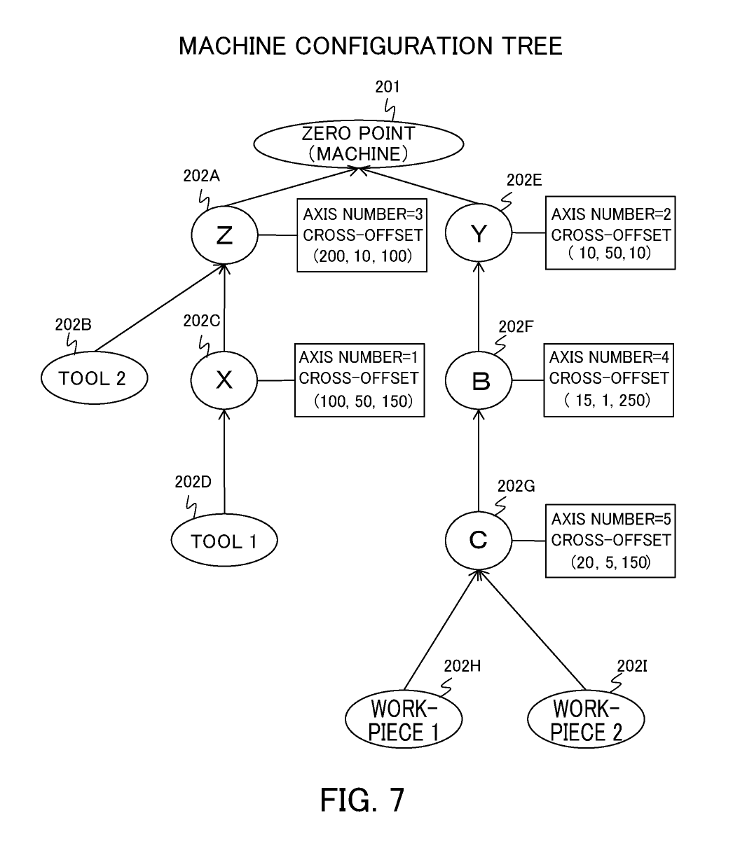

Then, the axis names (axis types) of the individual axes, the names of the individual tools, the names of the individual workpieces, the names of the individual zero points and the physical axis numbers (axis types) of the individual axes are set. Then, the parent nodes (axis types) of the individual axes, the parent nodes of the individual tools and the parent nodes of the individual workpieces are set. Finally, the cross-offsets (axis types) of the individual axes, the cross-offsets of the individual tools and the cross-offsets of the individual workpieces are set. Consequently, the machine configuration tree shown in FIG. 7 is generated.

Each node of the machine configuration tree is not limited to the pieces of information described above, and it may or may not have information related to, for example, an identifier (name), the identifier of the parent node of itself, the identifiers of all child nodes whose parents are itself, a relative offset (cross-offset) with respect to the parent node, a relative coordinate value with respect to the parent node, a relative movement direction (unit vector) with respect to the parent node, node types (linear axis/rotary axis/unit (which will be described later)/control point/coordinate system/zero point and the like), the physical axis number and the transformation formulas of an orthogonal coordinate system and a physical coordinate system.

As described above, values are set to the individual nodes, and thus data which has a data structure in the shape of a machine configuration tree is generated within the machine configuration management device 100. Furthermore, even when another machine (or robot) is added, a zero point is added, and thus it is possible to further add nodes.

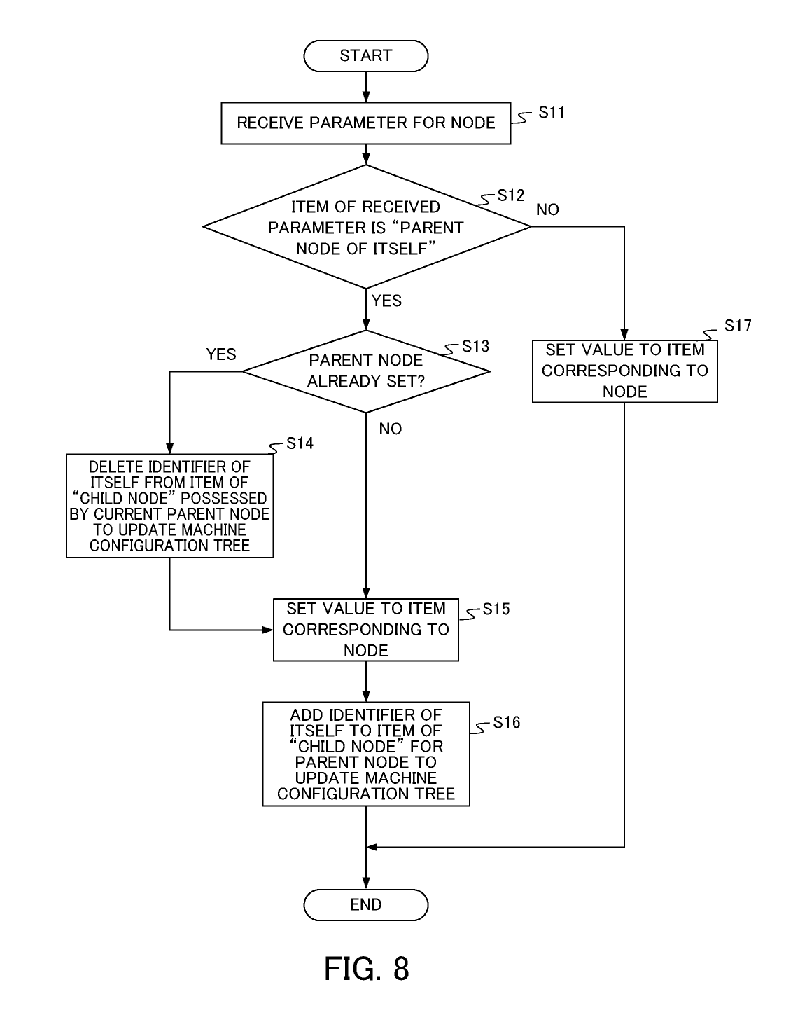

A flowchart obtained by generalizing the method of generating the machine configuration tree described above, in particular, the method of setting the values to the individual nodes is shown in FIG. 8.

In step S11, the graph generation portion 111 receives the value of a parameter set to the node. When in step S12, the item of the set parameter is “parent node of itself” (yes in S12), the processing is transferred to step S13. When the item of the set parameter is not “parent node of itself” (no in S12), the processing is transferred to step S17.

When in step S13, a parent node has already been set to the node to which the parameter is set (yes in S13), the processing is transferred to step S14. When a parent node has not been set (no in S13), the processing is transferred to step S15.

In step S14, the graph generation portion 111 deletes the identifier of itself from the item of “child node” possessed by the current parent node of the node to which the parameter is set so as to update the machine configuration tree.

In step S15, the graph generation portion 111 sets the value to the corresponding item of the node to which the parameter is set.

In step S16, the graph generation portion 111 adds the identifier of itself to the item of “child node” in the parent node so as to update the machine configuration tree, and thereafter the flow is completed.

In step S17, the graph generation portion 111 sets the value to the corresponding item of the node to which the parameter is set, and thereafter the flow is completed.

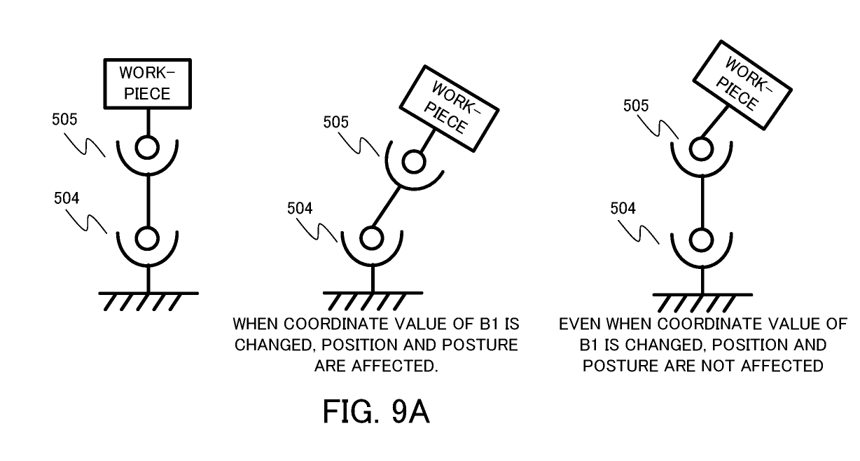

The method of generating the data having the data structure in the shape of the machine configuration tree described above is used, and thus it is possible to set a parent-child relationship of the constituent elements of the machine. Here, the parent-child relationship refers to a relationship in which, for example, when as shown in FIG. 9A, two rotary axis nodes 504 and 505 are present, a variation in the coordinate value of the node 504 on one side unilaterally affects the geometric state (typically, the position and the posture) of the node 505 on the other side. In this case, the nodes 504 and 505 are said to have a parent-child relationship, the node 504 is referred to as a parent and the node 505 is referred to as a child. However, for example, as shown in FIG. 9B, in a machine configuration that is configured with two linear axis nodes 502 and 503 and four free joints 501, a mechanism is present in which as the coordinate value (length) of one of the nodes 502 and 503 is varied, not only the geometric state of the other node but also the geometric state of itself is varied, that is, the nodes affect each other. In such a case, both of them are parents and children, and in other words, the parent-child relationship can be regarded as being bidirectional.

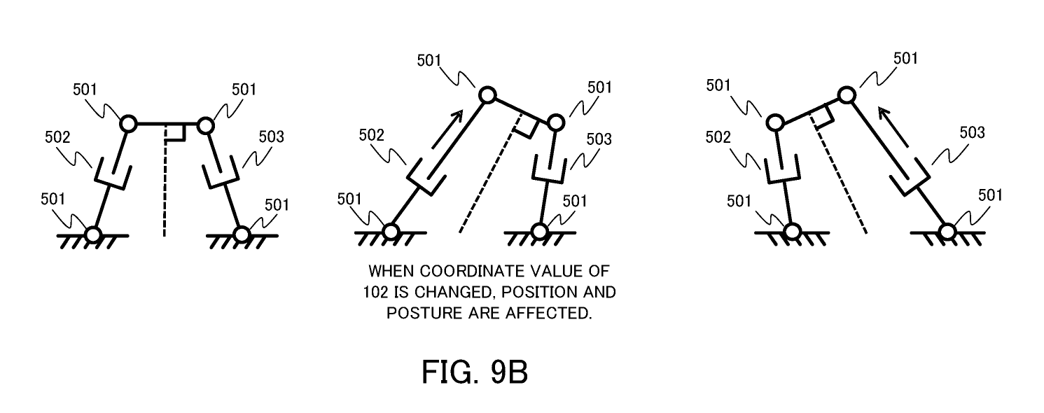

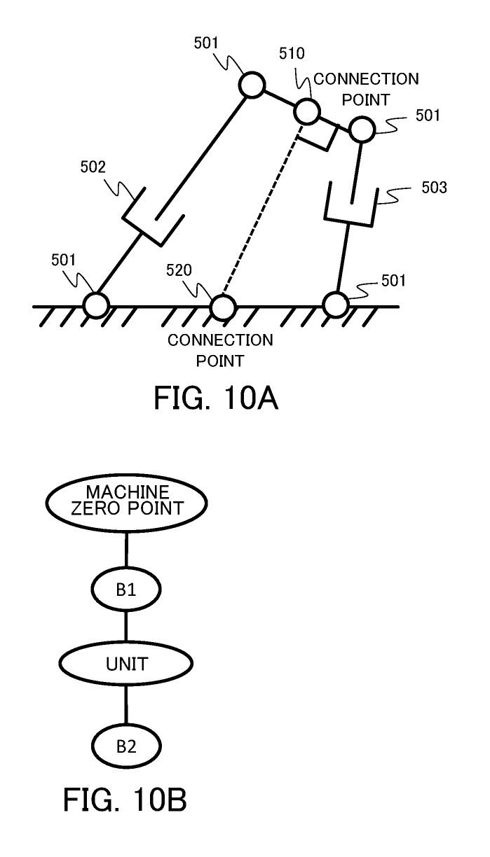

As described above, a mechanism in which a variation in a certain node affects the other node is regarded as one unit in terms of convenience, this unit is inserted into the machine configuration tree and thus the entire machine configuration tree is generated. As shown in FIG. 10A, the unit has two connection points 510 and 520, and when the unit is inserted into the machine configuration tree as shown in FIG. 10B, as shown in FIG. 10C, the parent node is connected to the connection point 520, and the child node is connected to the connection point 510. The unit also has a transformation matrix from the connection point 520 to the connection point 510. This transformation matrix is indicated by the coordinate values of the individual nodes included in the unit. For example, in the case of a machine configuration as shown in FIG. 11, when a homogeneous matrix indicating the position and the posture of the connection point 520 is assumed to be is M_{A} and a homogeneous matrix indicating the position and the posture of the connection point 510 is assumed to be M_{B}, a transformation formula between the matrices is represented as follows by use of the coordinate values x₁ and x₂ of the linear axis nodes included in the unit.

### [Formula 1]

When it is assumed that

$$θ = {sin}^{- 1} ( \frac{{x}_{1}^{2} - {x}_{2}^{2}}{4 {L}_{1} {L}_{2}} )$$

$$L = {L}_{1} cos θ + \sqrt{0.5 {x}_{1}^{2} + 0.5 {x}_{2}^{2} - {L}_{2}^{2} - {L}_{1}^{2} {sin}^{2} θ}$$

it is presented by
where

$${M}_{B} = {TM}_{A}$$

$$T = ( \begin{matrix}sin θ & 0 & cos θ & L cos θ \\ 0 & 1 & 0 & 0 \\ - cos θ & 0 & sin θ & L sin θ \\ 0 & 0 & 0 & 1\end{matrix} )$$

The unit indicating this machine configuration has a homogeneous transformation matrix such as T in the mathematical formula of [Formula 1] described above. The homogeneous matrix refers to a 4×4 matrix which can collectively represent the position and the posture as in the mathematical formula of [Formula 2] below.

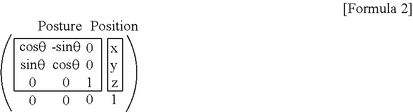

Even when the parent-child relationship is not mutual, in order for calculation processing or a setting to be simplified, a unit in which a plurality of nodes are previously integrated into one may be defined and configured into the machine configuration tree.

As described above, in the present embodiment, the graph of the machine configuration can include, as a constituent element, a unit in which a plurality of axes are integrated into one.

### <6. Automatic Insertion of Control Point and Coordinate System>

In order to specify, as the control points, various positions on the machine configuration and set coordinate systems in various places on the machine configuration, the following method is performed by use of the machine configuration tree generated in “5. Generation of machine configuration tree” described above.

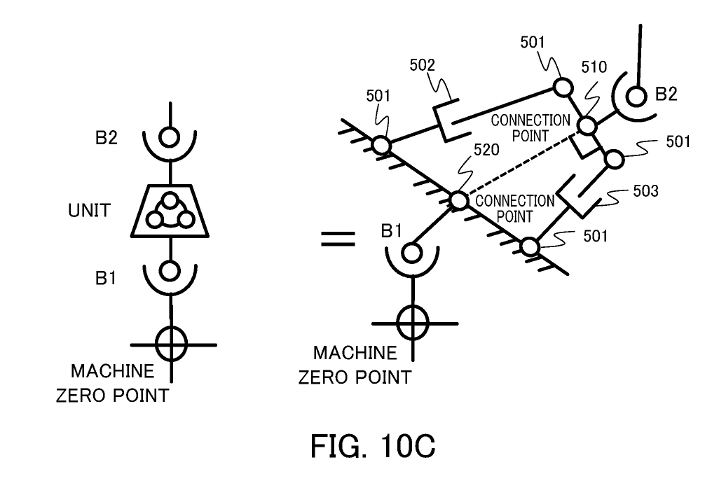

For example, in a rotary index machine 350 shown in FIG. 12A, an X1 axis is set perpendicular to a Z1 axis, and a tool 1 is installed in the X1 axis. An X2 axis is set perpendicular to a Z2 axis, and a tool 2 is installed on the X2 axis. Furthermore, it is assumed that in a table, on a C axis, a C1 axis and a C2 axis are set in parallel, and in the C1 axis and the C2 axis, a workpiece 1 and a workpiece 2 are respectively installed. When this machine configuration is represented by a machine configuration tree, the machine configuration tree shown in FIG. 12B is provided.

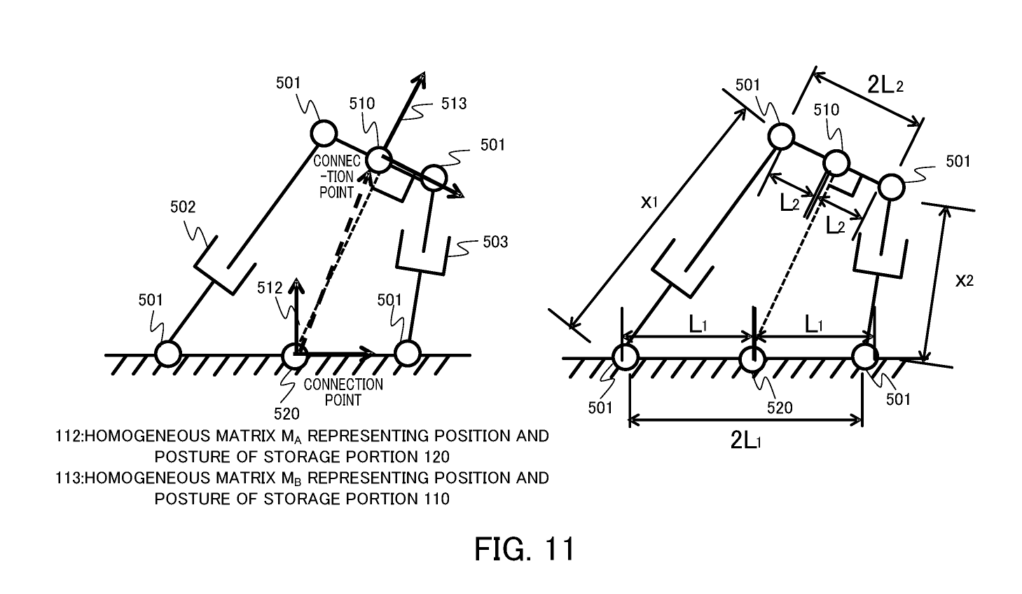

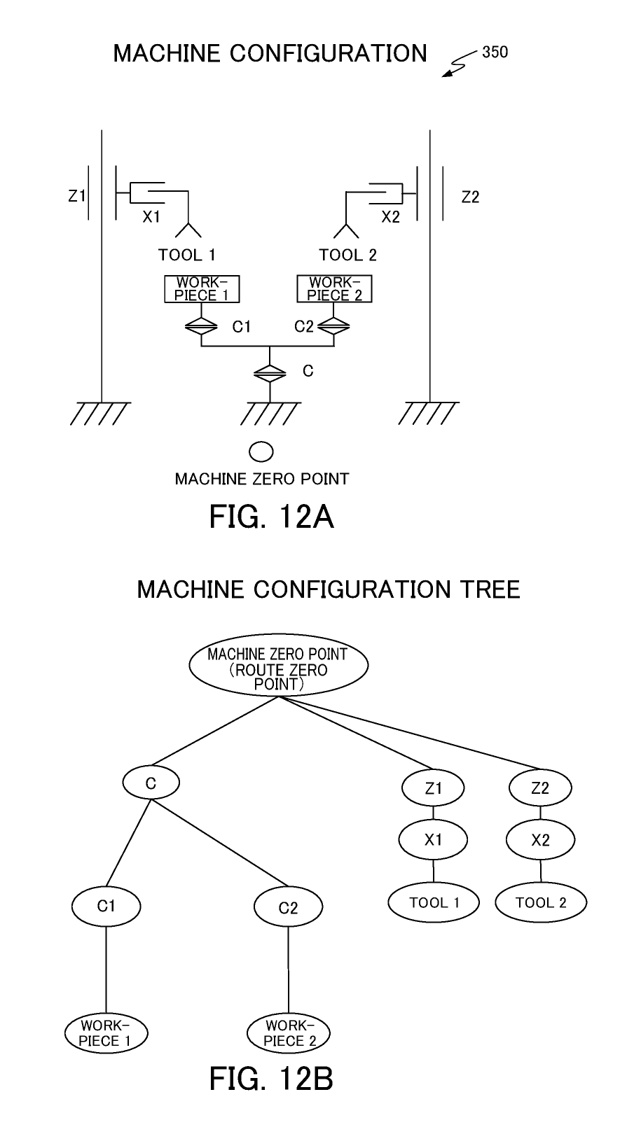

In an example of a series of nodes leading from individual workpieces to the machine zero point, as shown in FIG. 13, a coordinate system and a control point are automatically inserted into each of the machine zero point, the C axis, the C1 axis, the C2 axis, the workpiece 1 and the workpiece 2. This is performed not only on the table but also on the series of nodes leading from individual tools to the machine zero point, that is, all the X1 axis, the X2 axis, the Z1 axis, the Z2 axis, the tool 1 and the tool 2. Consequently, as shown in FIG. 14, into all the nodes of the machine configuration tree, the control points and the coordinate systems corresponding to the individual nodes are automatically inserted. Normally, when machining is performed, the coordinate system is specified in the workpiece, and the tool is specified as the control point. In this way, for example, it is possible to cope with various cases such as a case where in order to move a workpiece itself to a predetermined position, the control point is desired to be specified in the workpiece and a case where in order to use a certain tool to polish another tool, the coordinate system is desired to be set in the tool itself.

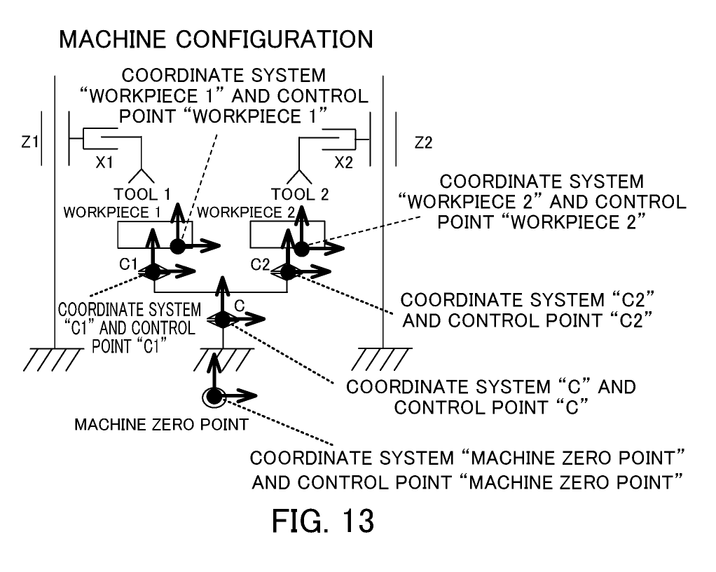

As shown in FIG. 15A, each of the control points and the coordinate systems has an offset. Hence, a point away from the center of the node can be set to a control point or a coordinate system zero point. Furthermore, each of the control points and the coordinate systems has a posture matrix. When this posture matrix is the posture matrix of the control point, it indicates the posture (the direction, the inclination) of the control point whereas when this posture matrix is the posture matrix of the coordinate system, it indicates the posture of the coordinate system. In a machine configuration tree shown in FIG. 15B, the offset and the posture matrix are represented so as to be associated with the nodes corresponding thereto. Furthermore, each of the control points and the coordinate systems has information on whether or not the “move” and the “cross-offset” of the node present on a path up to the route of the machine configuration tree are individually added, and the information can be set.

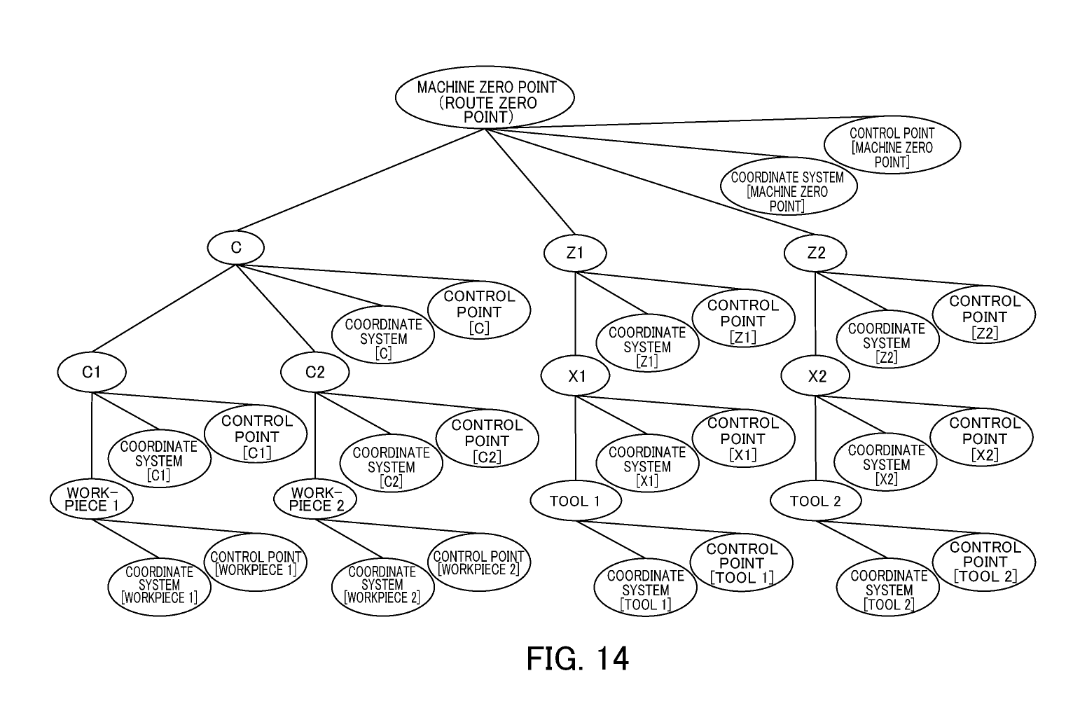

A flowchart obtained by generalizing the method of automatically inserting the control point described above is shown in FIG. 16. Specifically, this flowchart includes a chart A and a chart B, and as will be described later, the chart B is performed in the middle of the chart A.

The chart A will first be described. In step S21, the graph generation portion 111 sets a machine configuration tree. In step S22, the chart B is performed, and the flow of the chart A is completed.

The chart B will then be described. In step S31 of the chart B, when the control point and the coordinate system have been inserted into the node (yes in S31), the flow is completed. When the control point and the coordinate system have not been inserted into the node (no in S31), the processing is transferred to S32.

In step S32, the control point coordinate system insertion portion 113 inserts the control point and the coordinate system into the node, and stacks a variable n by 1. A setting is made such that n=1.

In step S33, when the n^{th} child node is present in the node (yes in S33), the processing is transferred to step S34. When the n^{th} child node is not present in the node (no in S33), the processing is transferred to step S36.

In step S34, on the n^{th} child node, the chart B itself is performed in a recursive manner.

In step S35, n is incremented by 1. In other words, the increment is performed such that n=n+1, and the processing is returned to step S33.

In step S36, the variable n is popped by 1, and the flow of the chart B is completed.

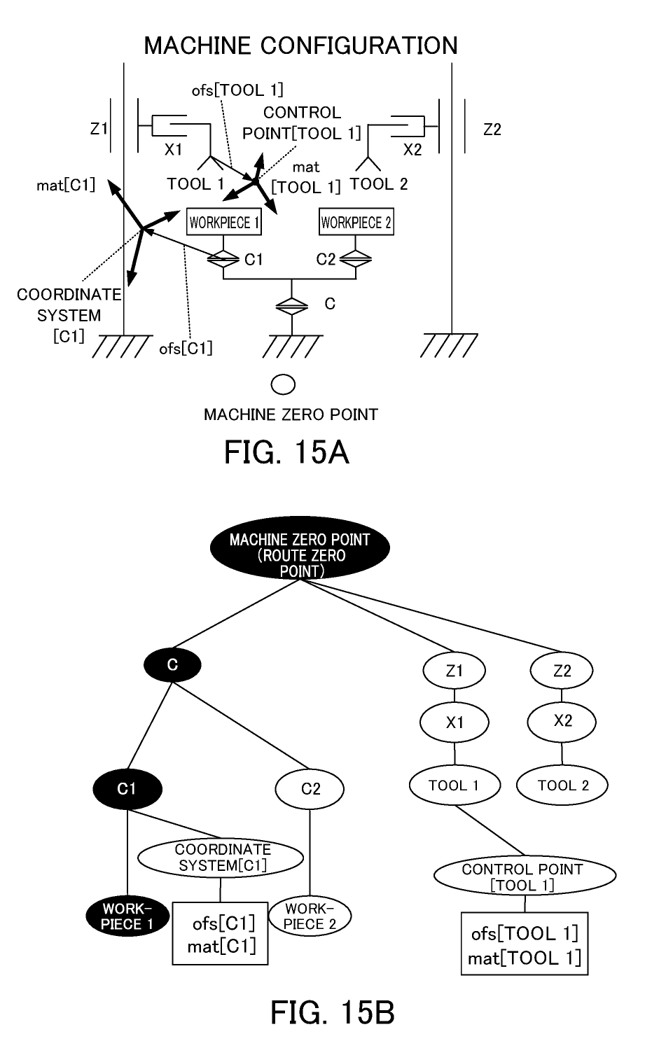

By the method described above, the control point coordinate system insertion portion 113 inserts, as nodes, the control points and the coordinate systems into the individual nodes of the graph in the machine configuration. Although in the above description, the example where the control points and the coordinate systems are added as nodes is described, an embodiment is also possible in which as shown in FIG. 17, the control point coordinate system insertion portion 113 makes the individual nodes of the graph in the machine configuration have the control points and the coordinate systems as information.

### <7. Calculation of Transformation Information>

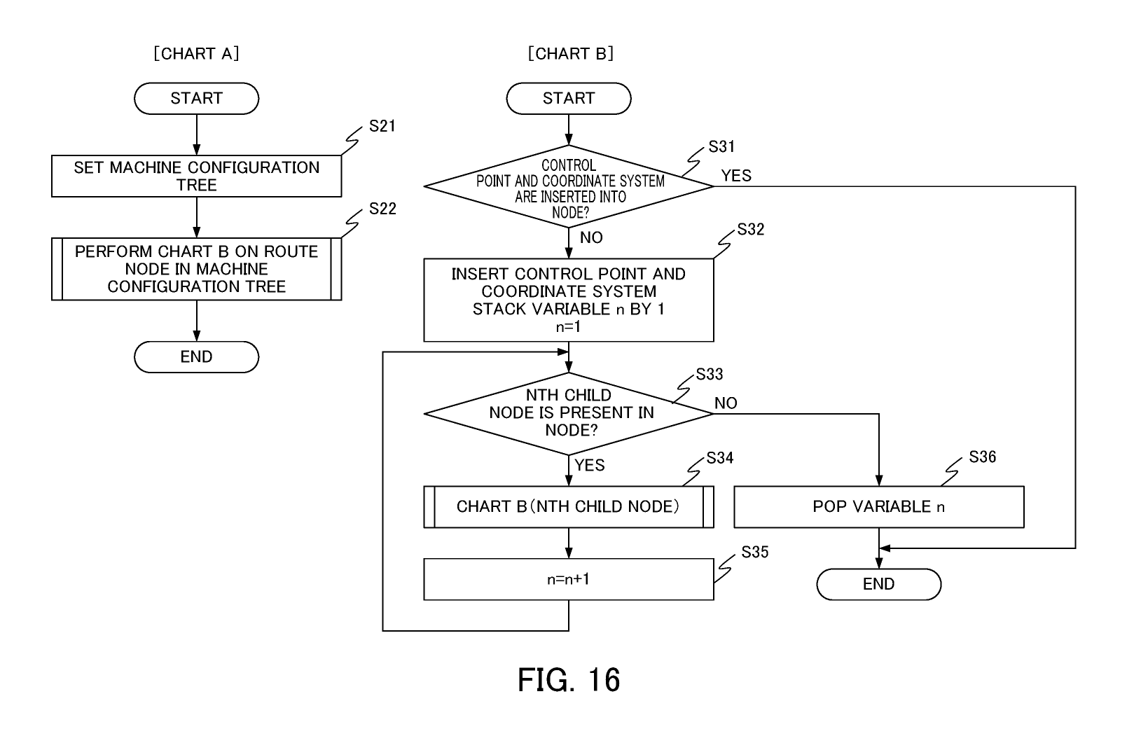

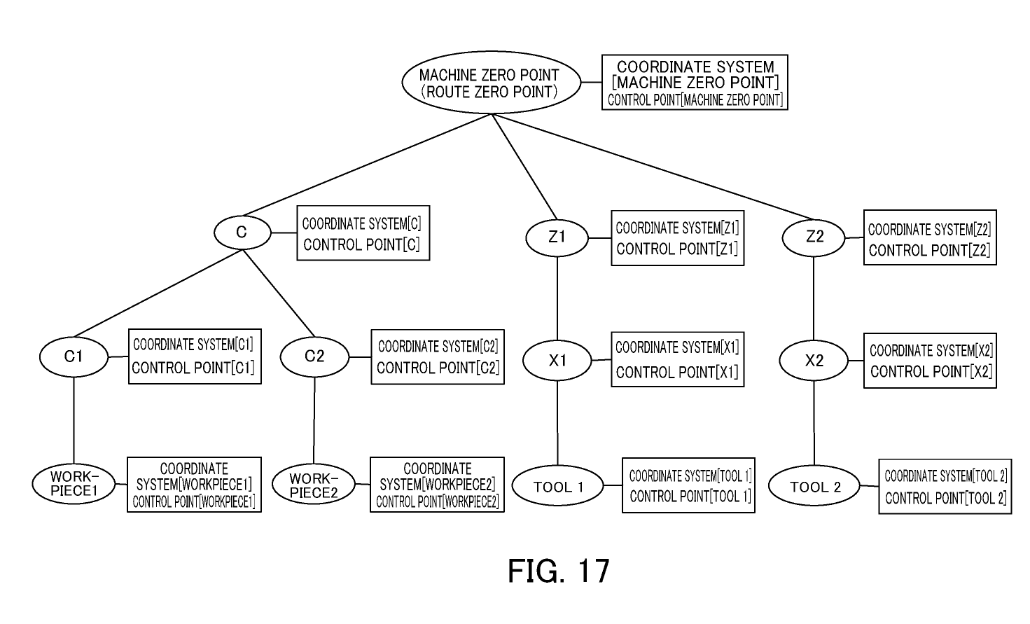

As described above, the transformation information calculation portion 115 calculates the transformation information for transforming the coordinate value of the control axis into the positon and/or the posture of the virtual object in the marker coordinate system. A method of calculating the transformation information will be described in detail with reference to FIGS. 18 and 19.

For example, as shown in FIG. 18, it is assumed that an axis X₂ is set on an axis X₁, that an axis X₃ is set on the axis X₂, that then, N nodes are likewise continuous and that the end thereof is an axis X_{N}. Furthermore, it is assumed that on the control point on the axis X_{N}, a virtual object is displayed. Likewise, it is assumed that an axis y₂ is set on an axis y₁, that an axis y₃ is set on the axis y₂, that then, L nodes are likewise continuous and that the end thereof is an axis y_{L}. Furthermore, it is assumed that on the axis y_{L}, a marker is installed. Here, although Xᵢ and yⱼ are the names of nodes, it is assumed that they simultaneously indicate the coordinate values of the individual nodes.

Furthermore, it is assumed that the offset, the type of node (linear line/rotation/unit/control point/coordinate system), the axis direction, the posture matrix and the coordinate value shown in FIG. 18 are given to the individual nodes.

Here, as shown in FIG. 19, the homogeneous matrix M_{obj} indicating the current position and posture of the virtual object on the control point with respect to the route (machine zero point) is determined by a formula below.

M_{obj}=(Πᵢ₌₁^{N}Sₓ_{ᵢ})M_{ctrl} where Πᵢ₌₁^{N}Sₓ_{ᵢ}=Sₓ_{₁}Sₓ_{₂} . . . Sₓ_{_{N}} [Formula 3]
Here, the meanings of symbols are as follows:
Sₓ₁: homogeneous transformation matrix by individual nodes;
N: number of a series of nodes leading from the route of the machine configuration tree to the control point; and
M_{ctrl}: homogeneous matrix of relative offset/posture for the parent node of the control point which is defined according to [Formula 2] described above from an offset vector/posture matrix defined in the control point.

The homogeneous transformation matrix Sₓᵢ is varied depending on the type of node, and for example, in the case of a linear axis, the homogeneous transformation matrix is represented as follows.

$${S}_{{x}_{i}} = ( \begin{matrix}1 & 0 & 0 & \\ 0 & 1 & 0 & \vec{of {s}_{{x}_{i}}} \\ 0 & 0 & 1 & \\ 0 & 0 & 0 & 1\end{matrix} ) ( \begin{matrix}1 & 0 & 0 & \\ 0 & 1 & 0 & {x}_{i} \vec{{v}_{{x}_{i}}} \\ 0 & 0 & 1 & \\ 0 & 0 & 0 & 1\end{matrix} ) \qquad [ Formula 4 ]$$

Here, the meanings of symbols are as follows:
x₁: coordinate value of a node x₁;
of Sₓᵢ: relative offset vector for the parent node of the node xᵢ; and
vxi: movement direction vector of the node xᵢ.

In the case of a rotary axis, the homogeneous transformation matrix is represented as follows.

$${S}_{{x}_{i}} = ( \begin{matrix}1 & 0 & 0 & \\ 0 & 1 & 0 & \vec{of {s}_{{x}_{i}}} \\ 0 & 0 & 1 & \\ 0 & 0 & 0 & 1\end{matrix} ) R ( {x}_{i} , {v}_{1} , {v}_{2} , {v}_{3} ) \\ R ( {x}_{i} , {v}_{1} , {v}_{2} , {v}_{3} ) = ( \begin{matrix}{v}_{1}^{2} ( 1 - cos {x}_{i} ) + cos {x}_{i} & {v}_{1} {v}_{2} ( 1 - cos {x}_{i} ) - {v}_{3} sin {x}_{i} & {v}_{1} {v}_{3} ( 1 - cos {x}_{i} ) + {v}_{2} sin {x}_{i} & 0 \\ {v}_{1} {v}_{2} ( 1 - cos {x}_{i} ) + {v}_{3} sin {x}_{i} & {v}_{2}^{2} ( 1 - cos {x}_{i} ) + cos {x}_{i} & {v}_{3} {v}_{2} ( 1 - cos {x}_{i} ) - {v}_{1} sin {x}_{i} & 0 \\ {v}_{1} {v}_{3} ( 1 - cos {x}_{i} ) - {v}_{2} sin {x}_{i} & {v}_{2} {v}_{3} ( 1 - cos {x}_{i} ) + {v}_{1} sin {x}_{i} & {v}_{3}^{2} ( 1 - cos {x}_{i} ) + cos {x}_{i} & 0 \\ 0 & 0 & 0 & 1\end{matrix} ) \qquad [ Formula 5 ]$$

Here, the meanings of symbols are as follows;
v1: first component of the rotary axis direction vector of the node xᵢ;
v2: second component of the rotary axis direction vector of the node xᵢ; and
v3: third component of the rotary axis direction vector of the node xᵢ.

Here, a homogeneous matrix X representing the current positon and posture of the virtual object on the control point on the marker coordinate system is determined by a formula below using M_{obj}.

Xₘ=M_{coord}⁻¹(Π_{i=L}¹Sₓ_{ᵢ}⁻¹)M_{obj} where Π_{i=L}¹Sₓ_{ᵢ}⁻¹=Sₓ_{_{L}}⁻¹Sₓ_{_{L−1}}⁻¹ . . . Sₓ_{₁}⁻¹
Here, the meanings of symbols are as follows;
L: number of a series of nodes leading from the route of the machine configuration tree to the coordinate system; and
M_{coord}: homogeneous matrix of relative offset/posture for the parent node of the marker which is defined according to the mathematical formula of [Formula 2] described above from an offset vector/posture matrix defined in the coordinate system

### <8. Method of Displaying Virtual Object>

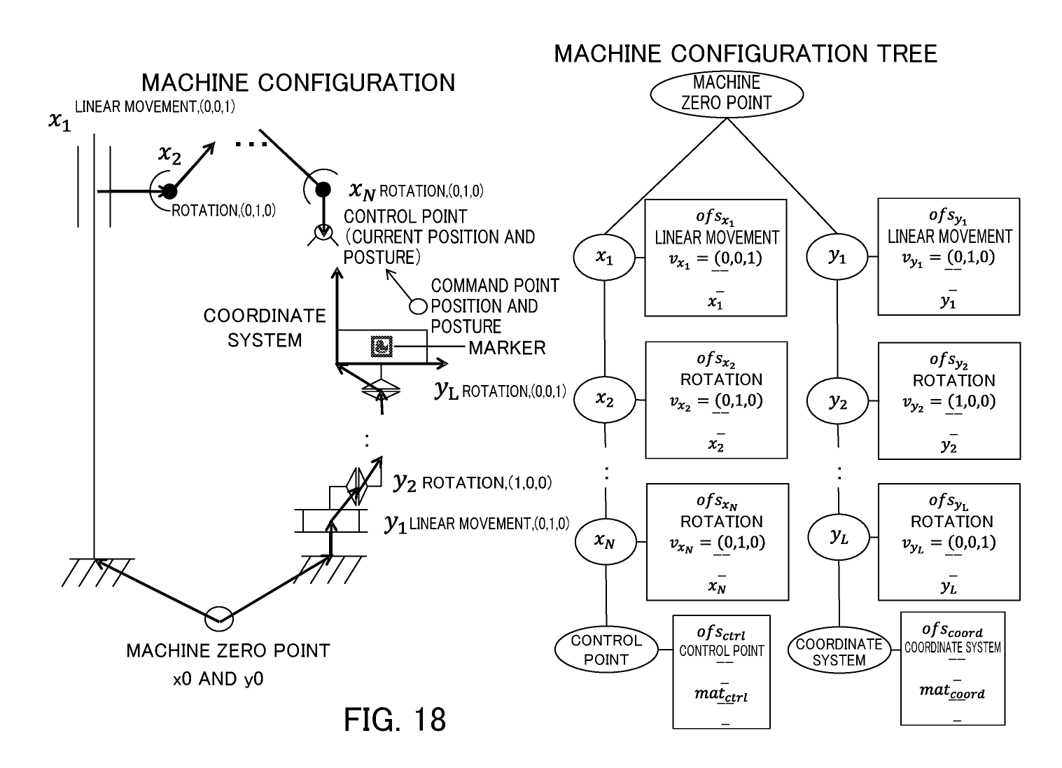

FIG. 20 shows an operation flow when a virtual object is displayed. First, individual steps will be schematically described.

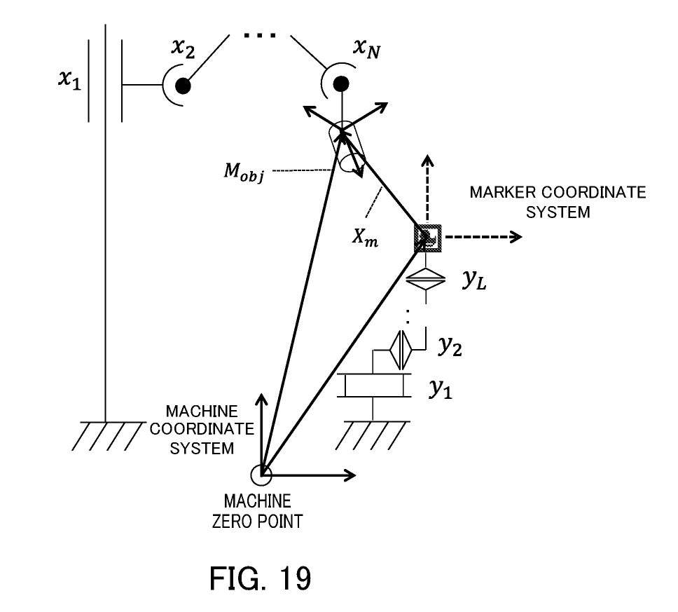

In step S41, the machine configuration management device 100 adds a marker node to the machine configuration tree as a new node. In this way, for example, when the configuration of the machine tool 400 is a configuration as shown in FIG. 21A, the marker node is added to the machine configuration tree showing the configuration of the machine tool 400 as shown in FIG. 21B.

In step S42, the augmented information controller 200 acquires, from the machine configuration management device 100, a node which can be displayed.

In step S43, the augmented information controller 200 selects a node on which the augmented information of the virtual object and the like is displayed, and notifies it to the machine configuration management device 100.

In step S44, the machine configuration management device 100 derives a formula for determining the position and the posture of the node required to be displayed in the marker coordinate system, and notifies it to the augmented information controller 200.

In step S45, the augmented information controller 200 acquires the coordinate values of the individual control axes from the numerical controller 150.

In step S46, the augmented information controller 200 uses the acquired coordinate values and the formula for determining the position and the posture in the marker coordinate system so as to determine the position and the posture of the node on which the augmented information of the virtual object and the like is displayed in the marker coordinate system.

In step S47, the augmented information controller 200 determines the position and the posture in the camera coordinate system by the transformation of the coordinate system from the position and the posture in the marker coordinate system.

In step S48, the augmented information controller 200 determines the position and the posture in the screen coordinate system by the transformation of the coordinate system from the position and the posture in the camera coordinate system.

In step S49, the augmented information controller 200 generates augmented information display data which is the display data of the augmented information of the virtual object and the like, and outputs it to the head mounted display 300.

In step S50, the head mounted display 300 displays the augmented information of the virtual object and the like. Thereafter, the processing is returned to step S45.

The position and the posture of the node on which the augmented information of the virtual object and the like is displayed in the marker coordinate system may be determined in the machine configuration management device 100, and values indicating the position and the posture themselves may be notified to the augmented information controller 200.

In steps S47 and S48 described above, the augmented information controller 200 uses a known method such as the method disclosed in Non-Patent Document 1 so as to determine the position and the posture in the camera coordinate system from the position and the posture in the marker coordinate system and determine the position and the posture in the screen coordinate system from the position and the posture in the camera coordinate system. More specifically, the three-dimensional position of the marker serving as the reference coordinates of a virtual object display is detected from image information obtained by a small-sized camera attached to the head mounted display 300, and thus processing for determining the transformation information from the marker coordinate system into the camera coordinate system is performed. By the transformation information, the position and the posture of the virtual object are transformed from the marker coordinate system into values in the camera coordinate system. Furthermore, processing for determining the transformation information from the camera coordinate system into the screen coordinate system is performed, and by the transformation information, the position and the posture of the virtual object are transformed from the camera coordinate system into values in the screen coordinate system. The augmented information display data includes, in addition to the positions and the postures in the camera coordinate system and the screen coordinate system determined here, the data of the shape and the like of the virtual object. The augmented information display data is output to the head mounted display 300, the output data is used and thus the head mounted display 300 can draw the virtual object in appropriate positions of left and right screens.

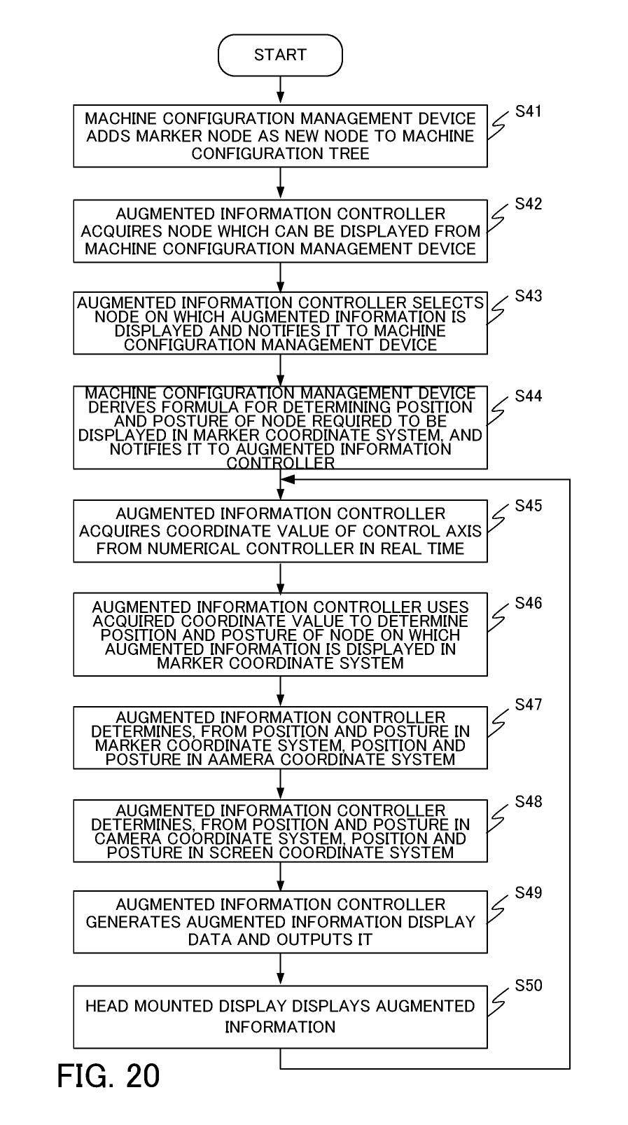

As shown in FIG. 22, when a position posture matrix in the marker coordinate system is assumed to be Xₘ, a position posture matrix in the camera coordinate system is assumed to be X_{c} and a transformation matrix from the marker coordinate system into the camera coordinate system is assumed to be M_{mc}, a formula 7 below holds true.

X_{c}=M_{mc}Xₘ [Formula 7]

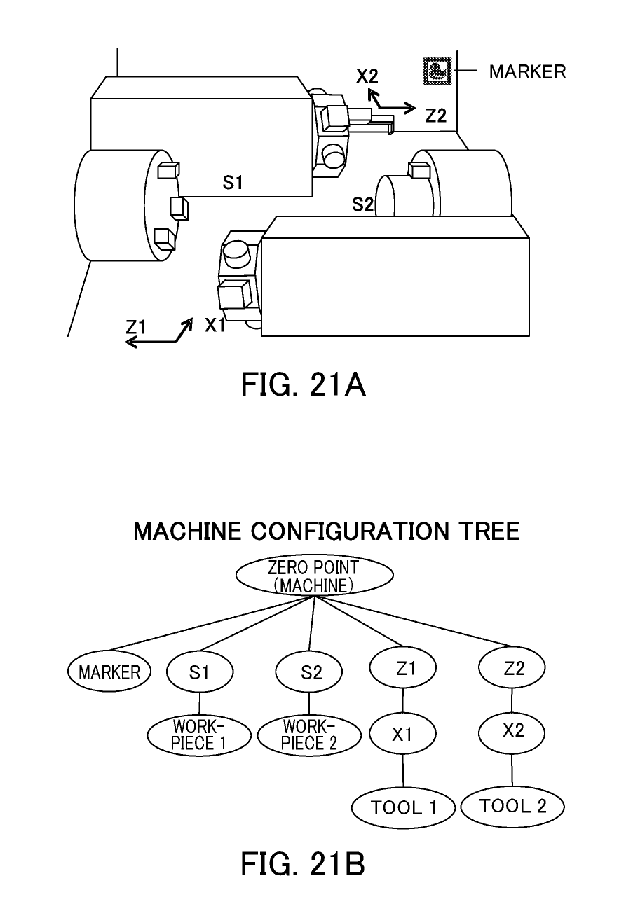

By the method described above, the position posture matrix X_{c} of the virtual objects in the camera coordinate system can be determined, and thus on the display, for an arbitrary node, the virtual object can be displayed. As shown in FIG. 23A, as the virtual objects, for example, 3D models for a workpiece and a tool may be arranged so as to be used for performing a machining simulation. Data which is associated with a node such as the number of revolutions of each spindle may be displayed. Furthermore, an acceleration sensor and a temperature sensor are arranged, and as shown in FIG. 23B, sensor nodes are added to the machine configuration tree, with the result that it is possible to visually check the acceleration and the temperature of each place. In this way, an operator of the machine tool 400 can check the data associated with the nodes and the numerical values of the sensors.

### <9. Effects Exerted by the Present Embodiment>

In the present embodiment, the markers are only recognized with the camera, and thus the virtual objects can be arranged on all the nodes registered on the graph. In particular, by the addition of a marker node, it is possible to add a virtual object in an arbitrary position, and it is not necessary to additionally register the transformation formula for the amount of movement and to additionally recognize a singular point. It is also not necessary to recognize the initial position.

### <10. Variations>

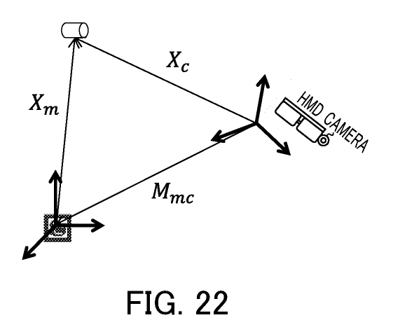

It can be considered that it is likely that the marker described above is seen or is not seen depending on the position of a viewpoint. Hence, in order to prevent a case where the marker is not seen, as shown in FIG. 24A, a plurality of markers may be set in the machine tool 400, and as shown in FIG. 24B, a plurality of marker nodes may be set in the graph. In such a case, it is possible to calculate the position and the posture of the virtual object with reference to any one of the markers which can be utilized. A plurality of markers are simultaneously used, the average value of the positions and the postures of the individual markers is utilized and thus it is possible to calculate the position and the posture of the virtual object. For another example, weights are assigned to the positions and the postures of the individual markers according to the distance from the viewpoint, and thus it is possible to calculate the position and the posture of the virtual object.

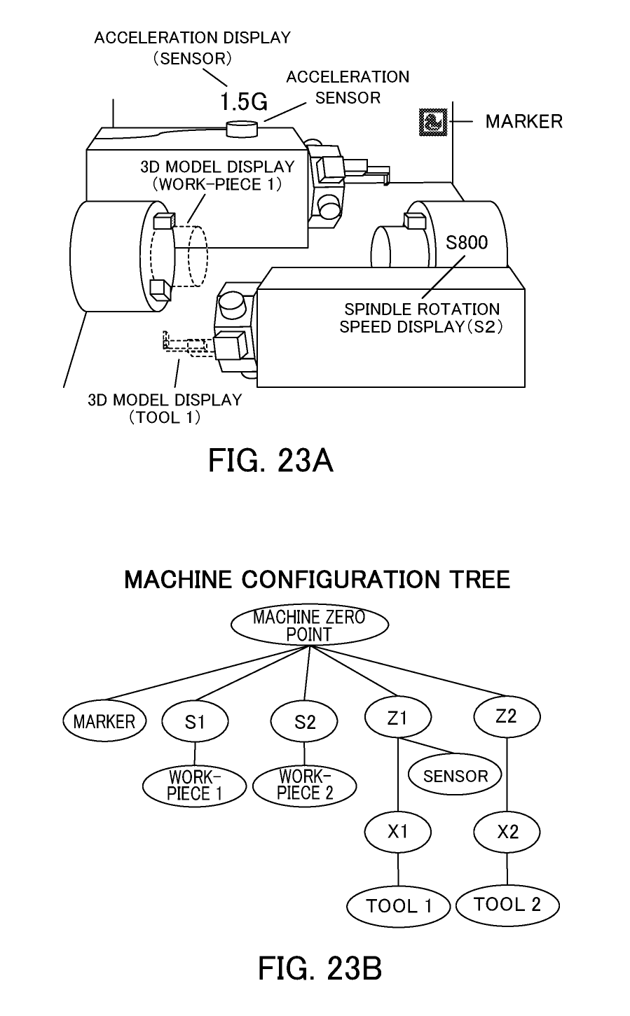

Furthermore, as shown in FIGS. 25A and 25B, in an arbitrarily determined position, a base marker node is set, and thus individual marker nodes can be registered as the children of the base marker node. In this case, the machine configuration management device 100 transmits, to the augmented information controller 200, the transformation information of individual virtual objects in a base marker coordinate system with the base marker set to a zero point and transformation information from individual marker coordinate systems into the base marker coordinate system. The former transformation information is not changed when any marker is used. The augmented information controller 200 determines the position and the posture of the base marker according to the recognized marker by use of the latter transformation information from the position and the posture of the marker, and further determines the transformation information from the base marker coordinate system into the camera coordinate system.

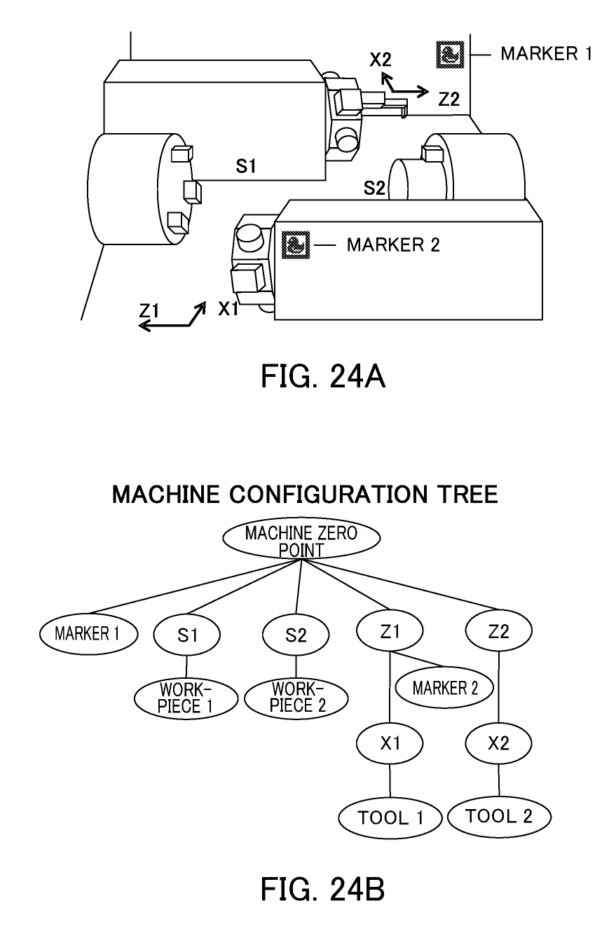

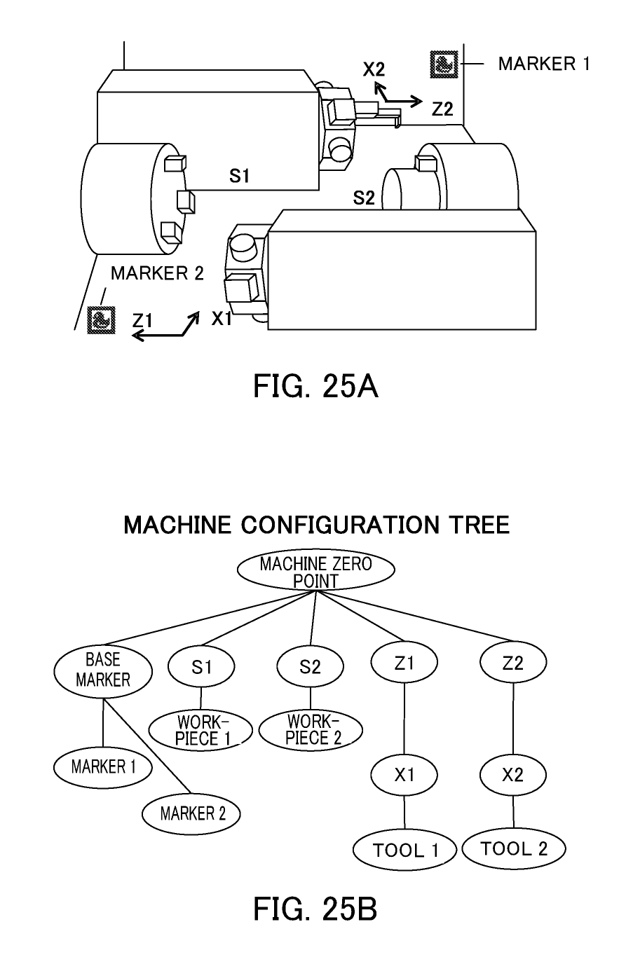

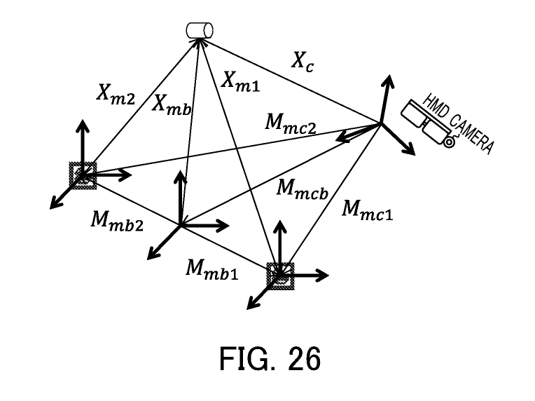

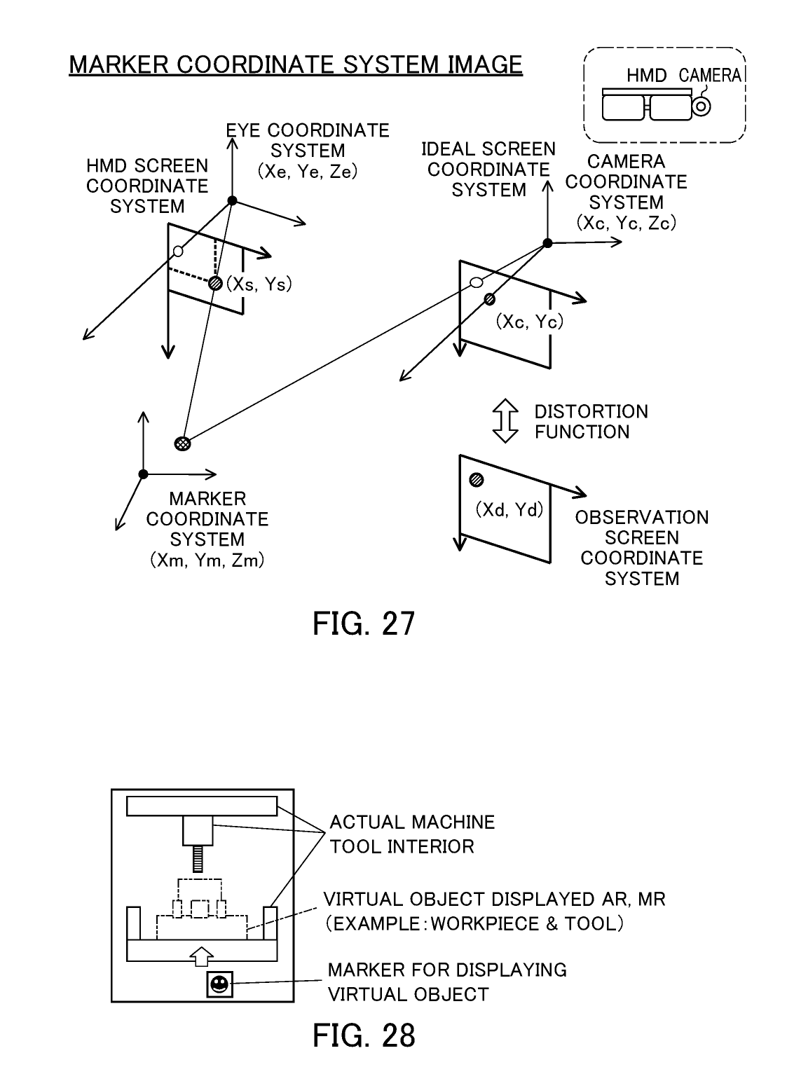

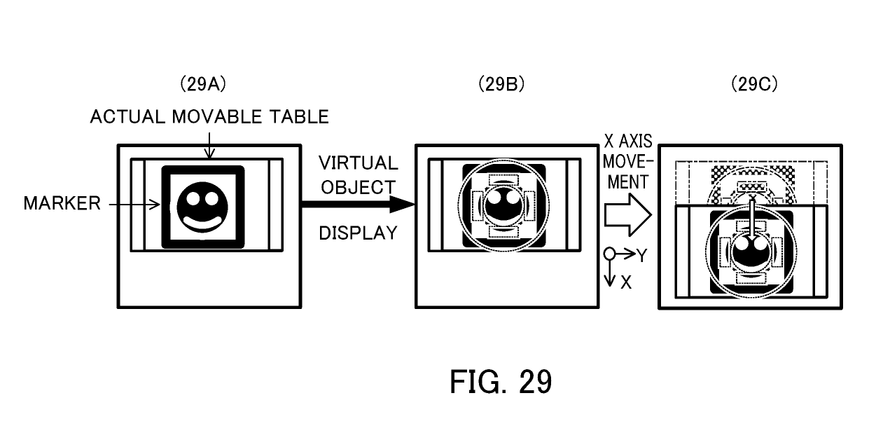

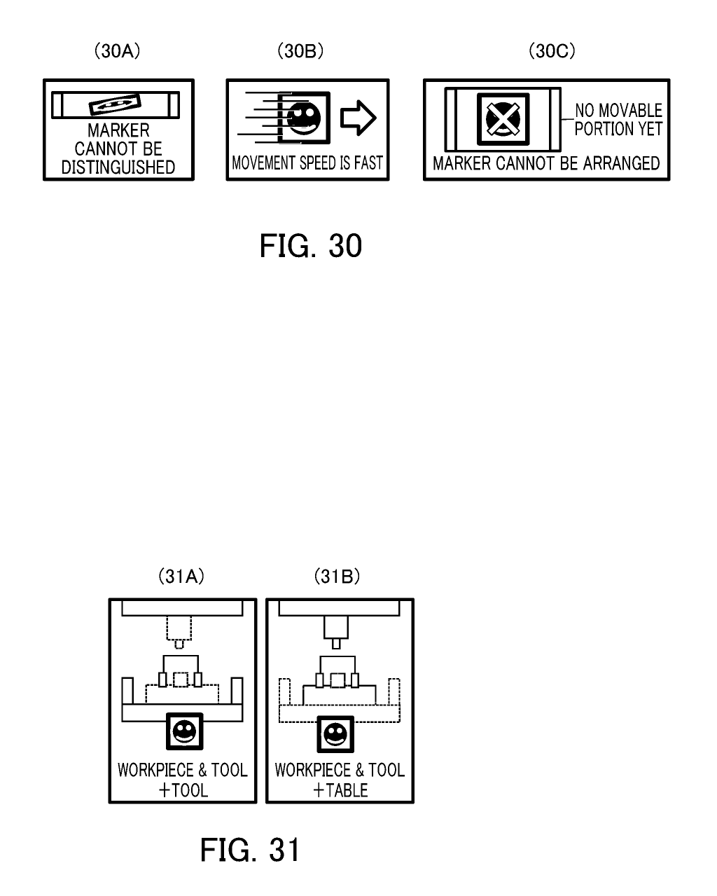

Here, as shown in FIG. 26, a position posture matrix in the camera coordinate system is assumed to be X_{c}, a position posture matrix in a marker coordinate system 1 is assumed to be Xₘ₁, a position posture matrix in a marker coordinate system 2 is assumed to be Xₘ₂ and a position posture matrix in the base marker coordinate system is assumed to be X_{mb}. A transformation matrix from the base marker coordinate system into the camera coordinate system is assumed to be M_{mcb}, a transformation matrix from the marker coordinate system 1 into the camera coordinate system is assumed to be M_{mc1}, a transformation matrix from the marker coordinate system 2 into the camera coordinate system is assumed to be M_{mc2}, a transformation matrix from the marker coordinate system 1 into the base marker coordinate system is assumed to be M_{mb1} and a transformation matrix from the marker coordinate system 2 into the base marker coordinate system is assumed to be M_{mb2}. In this case, a formula below holds true.

X_{c}=M_{mcb}X_{mb}

M_{mcb}=kM_{mc1}M_{mb1}⁻¹+(1−k)M_{mc2}M_{mb2}⁻¹

X_{mb}=kM_{mb1}Xₘ₁+(1−k)M_{mb2}Xₘ₂ [Formula 8]

Here, k is a coefficient for determining the weight of a marker, and for example, when both markers are used, k is 0.5, when only the marker 1 is used, k is 1 and when only the marker 2 is used, k is 0. Processing for dealing with a plurality of markers is integrated into processing for determining the position and the posture of the base marker node and processing for determining the transformation information from the base marker node coordinate system into the camera coordinate system, and the other processing is the same processing as when a single marker is used, with the result that it is easy to deal with a plurality of markers.

Although partially repeated, the graph data may be stored in the machine configuration management device 100 but there is no limitation to this configuration. For example, the graph data may be stored in the augmented information controller 200 or may be stored on a server which is connected to the virtual object display system 10 through a network. The data of the machine configuration tree can be stored in the augmented information controller 200 or on the server, and thus the present invention can be applied to even an old machine tool. In this case, the above-described processing until step S43 is not performed, and step S44 is performed on the side of the augmented information controller 200.

The machine configuration management device 100 may be incorporated so as to be integrated into the numerical controller 150. The machine configuration management device 100 may also be present on a cloud.

The machine configuration management device, the numerical controller, the augmented information controller and the machine tool each can be realized by hardware, software or a combination thereof. The simulation method performed by the cooperation of the machine configuration management device, the numerical controller, the augmented information controller and the machine tool can also be realized by hardware, software or a combination thereof. Here, the realization by software means that the realization is achieved by reading and performing programs with a computer.

The programs are stored with various types of non-transitory computer readable media, and can be supplied to a computer. The non-transitory computer readable media include various types of tangible storage media. Examples of the non-transitory computer readable medium include magnetic storage media (for example, a flexible disk, a magnetic tape and a hard disk drive), magneto-optical storage media (for example, a magneto-optical disk), a CD-ROM (Read Only Memory), a CD-R, a CD-R/W, semiconductor memories (for example, a mask ROM and a PROM (Programmable ROM), an EPROM (Erasable PROM), a flash ROM and a RAM (random access memory). The programs may be supplied with various types of transitory computer readable media to a computer. Examples of the transitory computer readable medium include an electrical signal, an optical signal and electromagnetic waves. The transitory computer readable medium can supply the programs to a computer through a wired communication path such as an electrical wire or an optical wire or a wireless communication path.

### EXPLANATION OF REFERENCE NUMERALS

10 virtual object display system
100 machine configuration management device
110 control portion
111 graph generation portion
112 node addition portion
113 control point coordinate system insertion portion
114 node information notification portion
115 transformation information calculation portion
116 transformation information notification portion
120 storage portion
150 numerical controller
160 control portion
161 coordinate information notification portion
162 servomotor control portion
200 augmented information controller
211 node selection portion
212 selection node notification portion
213 coordinate information transformation portion
214 augmented information display data calculation portion
215 augmented information display data notification portion
220 storage portion
250 wireless communication device
300 head mounted display
400 machine tool

What is claimed is:

1. A virtual object display system which comprises a machine configuration management device and an augmented information controller, in which the machine configuration management device includes a graph generation portion, a control point coordinate system insertion portion, a node information notification portion, a transformation information calculation portion and a transformation information notification portion and in which the augmented information controller includes a node select on portion, a selection node notification portion and a coordinate information transformation portion,
wherein the graph generation portion generates, as a machine configuration of a control target, a graph in which constituent elements including markers are nodes,
the control point coordinate system insertion portion inserts a control point and a coordinate system into the graph,
the node information notification portion notifies information of a node which can be displayed to the augmented information controller,
the node selection portion selects a node on which a virtual object is desired to be displayed,
the selection node notification portion notifies the node on which the virtual object is desired to be displayed to the machine configuration management device,
the transformation information calculation portion calculates transformation information which includes, as a variable, a coordinate value of a control axis node on a path in the graph from a marker node to a node of a display target and which is used for calculating a position and/or a posture of the node of the display target in a coordinate system of the marker node based on the graph,
the transformation information notification portion notifies the transformation information to the augmented information controller and
the coordinate information transformation portion uses the transformation information so as to transform the coordinate value of a control axis which is notified into the position and/or the posture of the node of the display target in the coordinate system of the marker node.

2. The virtual object display system according to claim 1, further comprising a display device,
wherein the augmented information controller further includes: an augmented information display data calculation portion which calculates, based on the position and/or the posture of the node of the display target in the coordinate system of the marker node, augmented information display data for calculating, with the display device, the virtual object as augmented information; and an augmented information display data notification portion which notifies the augmented information display data to the display device.

3. The virtual object display system according to claim 1, wherein the coordinate information transformation portion transforms, as the coordinate value of the control axis, a coordinate value received from a numerical controller into the position and/or the posture of the node of the display target in the coordinate system of the marker node.

4. The virtual object display system according to claim 1, wherein the graph generation portion adds a plurality of the marker nodes to the graph,
the transformation information calculation portion calculates the transformation information for calculating the position and/or the posture of the node from the coordinate system of the marker nodes and
the transformation information notification portion notifies the transformation information to the augmented information controller.

5. The virtual object display system according to claim 1, wherein the graph generation portion adds a base marker node, and
the transformation information calculation portion notifies the augmented information controller of the transformation information with reference to the coordinate system of the base marker node and the transformation information between the coordinate system of the base marker node and the coordinate system of the marker node.

6. The virtual object display system according to claim 1, wherein the augmented information controller further includes a storage portion having data of the graph.

7. The virtual object display system according to claim 1, further comprising a server which stores data of the graph.

8. The virtual object display system according to claim 1, wherein the machine configuration management device is integrated with a numerical controller of a machine tool.

9. The virtual object display system according to claim 1, wherein the machine configuration management device is present on a cloud.
